(19) United States
(12) Patent Application Publication
(10) Pub. No.: US 2022/0412872 A1
(43) Pub. Date: Dec. 29, 2022

(54) LINEAR FOURIER FIDUCIAL

(71) Applicant: ILLUMINA CAMBRIDGE LTD., Cambridge (GB)

(72) Inventor: Helge Nareid, Cambridge (GB)

(21) Appl. No.: 17/592,895

(22) Filed: Feb. 4, 2022

Related U.S. Application Data
(60) Provisional application No. 63/215,152, filed on Jun. 25, 2021.
(60) Provisional application No. 63/216,898, filed on Jun. 30, 2021.

(51) Int. Cl. G01N 15/14; G06T 7/73

(52) U.S. Cl. CPC G01N 15/1436; G06T 7/73; G06T 2207/30204; G06T 2207/20056; G01N 2015/1006

(57) ABSTRACT

The present approach relates generally to image-based approaches for detecting deviations from a linear movement when scanning a surface. More particularly, the approach relates to the use of linear fiducials to detect, in real-time, deviations from a linear scan path during operation of a scanning imaging system. Such linear fiducials may include both sample sites and blank regions or sites or, in certain embodiments, may utilize elongated sample sites (e.g., linear features) within the linear fiducial.

### CROSS-REFERENCE TO RELATED APPLICATION

This application claims priority to and the benefit of U.S. Provisional Application No. 63/215,152, entitled “LINEAR FOURIER FIDUCIAL”, filed Jun. 25, 2021 and U.S. Provisional Application No. 63/216,898, entitled “LINEAR FOURIER FIDUCIAL”, filed Jun. 30, 2021, both which are herein incorporated by reference in its entirety.

### BACKGROUND

The present approach relates generally to image-based approaches for detecting deviations from a linear movement when scanning a surface. More particularly, the approach relates to the use of linear fiducials to detect, in real-time, deviations from a linear scan path during operation of a scanning imaging system.

In a nucleic acid sequencing context, a sample holder, such as a flow cell or other sequencing substrate, for use in a sequencing instrument may provide a number of individual sites (e.g., sample wells or nanowells) at permanently or transiently fixed locations on a surface. Such sites may contain chemical groups or biological molecules, which can be identical or different among the many sites, and can interact with other materials of interest, such as a biological sample. Sites can be located and/or analyzed by taking an image of the substrate surface, such as by taking a planar image or by line scanning. The image data may be processed to locate and identify at least a portion of the sites and/or to obtain qualitative or quantitative measurements related to samples being analyzed. In such a context, where a chemical or biological interaction occurs at a particular site, the interaction may be detected at the site and correlated with the location and identity of the site, as well as the particular group or molecule present at the site.

For sequencing instruments using a scanning imaging system, any transverse movement of the moving stage during scanning can cause deterioration of the sequencing data extracted from the acquired images. Straight line movements at a skew angle can be detected and compensations applied. However, typically there has not been a suitable method for detecting and compensating for deviations from straight line movement. Such deviations from linear movement can, in a sequencing context, impact the quality of the sequencing operation as such operations typically require that the location of each sample cluster is accurate to 0.1 to 0.2 pixels. On current systems, this equates to approximately 70 nm. Further, it is anticipated that higher density flow cells under development may require accuracy of 40 nm or better. It is believed that deviations from linear movement of this magnitude may occur frequently using conventional readout approaches. Hence, detecting and compensating for deviations from linear motion is relevant in such sequencing contexts.

### SUMMARY

The present invention provides an article of manufacture, comprising a substrate, on which a plurality of sites are disposed at fixed, physical locations on the surface of the substrate. An example of such an article may include a patterned arrangement of sites associated with a sequencing flow cell, where some or all of the sites may be configured to hold a material of interest.

In one embodiment, a substrate is provided that is suitable for linear scanning. In accordance with various implementations of such an embodiment, sample sites or wells (e.g., nanowells) may be arranged on non-fiducial regions of the substrate in a periodic or repeating pattern (e.g., a hexagonal or rectilinear pattern). Conversely, in fiducial regions, a fiducial (e.g., a linear fiducial) may be provided that is a combination of sample sites and “blank” regions or wells (e.g., locations where a well would normally be formed (e.g., nano-imprinted) in accordance with the non-fiducial pattern but where no well was formed (or fully formed) during fabrication or where a well has been formed but which contains no sample. By way of example, in various embodiments discussed herein a fiducial (e.g., a linear fiducial) may comprise a full row of sample sites between respective rows of “blank” sites or wells; a partial row of sample sites (e.g., alternating sample wells and “blanks”) between respective rows of “blank” sites or wells; or multiple rows, each row comprising both sample sites and “blanks” but in which every row has at least one sample site (i.e., there are no “site-free” rows within the fiducial).

With the preceding in mind, a respective embodiment a patterned flow cell is provided. In accordance with this embodiment, the patterned flow cell comprises: a substrate and a plurality of sample sites in a non-fiducial region of the substrate. The plurality of sample sites are arranged in a periodic pattern. The patterned flow cell further comprises a plurality of coarse-alignment fiducials formed on the substrate separate from the plurality of sample sites and a plurality of linear fiducials formed on the substrate. Each linear fiducial comprises sample sites and blanks arranged in accordance with the periodic pattern. Each blank corresponds to a location in the periodic pattern where a sample site should be located but is not or where an empty sample site is located.

In a further embodiment a patterned flow cell is provided. In accordance with this embodiment, the patterned flow cell comprises: a substrate and a plurality of sample sites in a non-fiducial region of the substrate. The plurality of sample sites are arranged in a periodic pattern. The patterned flow cell further comprises a plurality of coarse-alignment fiducials formed on the substrate separate from the plurality of sample sites and a plurality of linear fiducials formed on the substrate. Each linear fiducial comprises elongated sample sites. Each elongated sample site spans the area associated with two or more sample sites.

In another embodiment, a method is provided for correcting for deviations from a linear scan path in an imaging operation. In accordance with this method a patterned surface undergoing an imaging operation is advanced along a linear scan path. The patterned surface is imaged as it is advanced along the linear scan path. The patterned surface comprises a plurality of linear fiducials. Deviations from the linear scan path are detected using the plurality of linear fiducials. The deviations from the linear scan path are corrected for while the patterned surface is imaged.

In a further embodiment, a sequencing instrument is provided. In accordance with this embodiment, the sequencing instrument comprises: a sample stage configured to support a sample container; an objective lens, a photodetector, and a light source configured to operate in combination to image the sample container when present on the sample stage; and a controller configured to perform operations comprising: advancing the sample container undergoing an imaging operation along a linear scan path; imaging a patterned surface of the sample container as it is advanced along the linear scan path, wherein the patterned surface comprises a plurality of linear fiducials; detecting deviations from the linear scan path using the plurality of linear fiducials; and correcting for the deviations from the linear scan path while the patterned surface is imaged by the sequencing instrument.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1 illustrates a high-level overview of one example of an image scanning system, in accordance with aspects of the present disclosure;

FIG. 2 is a block diagram illustration of an imaging and image processing system, such as for biological samples, in accordance with aspects of the present disclosure;

FIG. 3 is a diagrammatical overview of functional components that may be included in a data analysis system for use in a system of the type illustrated in FIG. 2;

FIG. 4 is a plan view of an example patterned surface, in accordance with aspects of the present disclosure;

FIG. 5 is an enlarged, cut-away view of a portion of the patterned surface of FIG. 4;

FIG. 6 is a further cut-away diagram illustrating sites on an example patterned flow cell surface, in accordance with aspects of the present disclosure;

FIG. 7 is an enlarged view of two example sites of a patterned flow cell surface illustrating pixilation in image data for the sites during processing;

FIG. 8 depicts a process flow of steps for correcting deviations from a linear scan path using linear fiducials, in accordance with aspects of the present disclosure;

FIGS. 9A and 9B respectively depict examples of an image tile incorporating both conventional fiducials and linear fiducials, in accordance with aspects of the present disclosure;

FIG. 10 depicts an example of a layout of a linear fiducial, in accordance with aspects of the present disclosure;

FIG. 11 depicts an example of a layout of a vertically arranged linear fiducial, in accordance with aspects of the present disclosure;

FIG. 12 depicts a further example of a layout of a linear fiducial, in accordance with aspects of the present disclosure;

FIG. 13 depicts another example of a layout of a linear fiducial, in accordance with aspects of the present disclosure;

FIG. 14 depicts an additional example of a layout of a linear fiducial, in accordance with aspects of the present disclosure;

FIG. 15 depicts a further example of a layout of a linear fiducial, in accordance with aspects of the present disclosure;

FIG. 16 depicts an additional example of a layout of a linear fiducial, in accordance with aspects of the present disclosure;

FIG. 17 depicts another example of a layout of a linear fiducial, in accordance with aspects of the present disclosure;

FIG. 18 depicts a further example of a layout of a linear fiducial, in accordance with aspects of the present disclosure;

FIG. 19 depicts an additional example of a layout of a linear fiducial, in accordance with aspects of the present disclosure; and

FIG. 20 depicts another example of a layout of a linear fiducial, in accordance with aspects of the present disclosure.

### DETAILED DESCRIPTION

This disclosure provides methods and systems for processing, imaging, and image data analysis that are useful for locating features of patterned surfaces, such as sites or wells of patterned flow cells, and for detecting deviations from linear motion in real-time during a scan operation. The systems and methods may be used to register multiple images or sub-images of such patterned surfaces. As discussed herein, patterned surfaces used in flow cells (the processing of which produces image data, or other forms of detection output, of sites on the surface) may be a type of analytical sample holder, such as those used for the analysis of biological samples. Such patterned surfaces may contain repeating patterns of features (e.g., sample sites, such as sample wells or nanowells) that are to be resolved at a suitable resolution (e.g., sub-micron resolution ranges) for which the methods and systems described herein are suited. In many applications, the material to be imaged and analyzed will be located on one or more surfaces of one or more supports, such as a glass material. Various chemical or structural features may be employed at sites to bind or anchor (or to otherwise localize) segments or fragments of material to be processed (e.g., hybridized, combined with additional molecules, imaged, and analyzed). Fiducial markers or regions, or simply “fiducials” are located at known locations with respect to the sites to assist in locating the support in the system (e.g., for imaging), and for locating the sites in subsequent image data. As discussed herein, certain fiducials, namely linear fiducials as described herein, may be formed, at least in part, from sites used in the processing of a biological sample (i.e., sample sites) but which are arranged so as to be optically discernible from the non-fiducial pattern of sample sites, which are typically arranged in a regular or periodic pattern (e.g., a hexagonal or rectilinear pattern). As used herein, such a regular or periodic pattern is translationally periodic, repeating in one or more directions.

As discussed in greater detail below, sequencing instruments that employ a scanning imaging system typically move the imaging optics relative to the imaged substrate during operation. Any transverse movement of the moving stage during scanning can cause deterioration of the sequencing data extracted from the acquired image. While straight line movements at a skew angle can be detected and compensated, there has not been a suitable approach for detecting and compensating for deviations from straight line movement. In a sequencing context, it is essential for base-calling quality that the location of each sample cluster is accurate to within 0.1 to 0.2 pixels. On current sequencing systems, this equates to approximately 70 nm. However, higher density flow cells under development may require accuracy of 40 nm or better. Unfortunately, analysis of data from current stages (which are configured to hold and move flow cells undergoing imaging) shows that deviations from linear movement of this magnitude may occur during normal operation at unacceptable rates.

In order to compensate for such deviations from a linear movement, deviations may be detected in real time during operation of the scanning imaging system. As discussed herein, approaches and structures are described that allow such real-time detection of deviations from linear movement. By way of example, certain embodiments employ a specialized, linear fiducial for high-resolution, real-time detection of transverse movement of the scanning system, such as using one-dimensional Fourier transforms of pixel rows.

It may be noted that as used herein, a “sequence flow cell”, including “patterned flow cells” may be understood to be a sample holding and/or processing structure or device. Such devices comprise sites (i.e., sample sites or binding sites) at which analytes may be located for processing and analysis.

As discussed herein, in a nucleic acid sequencing technique, oligomeric or polymeric chains of nucleic acids, which may be spatially separated and localized on a substrate, may be subjected to several cycles of biochemical processing and imaging. In some examples, each cycle can result in one of four different labels being detected at each feature, depending upon the nucleotide base that is processed biochemically in that cycle. In such examples, multiple (e.g., four) different images are obtained at a given cycle and each feature will be detected in the images. Sequencing includes multiple cycles, and alignment of features represented in image data from successive cycles is used to determine the sequence of nucleotides at each site based on the sequence of labels detected at the respective site. Improper registration of the images can adversely affect sequence analysis, including improper localization of a cluster at an imaged site due to deviation from the expected linear motion.

As used herein, the term “fiducial” is intended to mean a distinguishable region (e.g., point or area) of reference in or on an object (such as a support or substrate with sites for molecular materials to be analyzed) as well as in image data acquired of the object. The fiducial can be, for example, a mark, an object, shape, edge, area, irregularity, channel, pit, post, or, as in many cases, a collection of features at known locations, geometry, and/or configuration that can be used as a reference. The fiducial can be detected in an image of the object or in another data set derived from detecting (e.g., imaging) the object. The fiducial can be characterized by an x- and/or y-coordinate in a plane of the object (e.g., one or more surfaces of the patterned flow cell). Alternatively or additionally, the fiducial can be specified by a z-coordinate that is orthogonal to the x, y plane, for example, being defined by the relative locations of the object and a detector. One or more coordinates for a fiducial can be specified relative to one or more other features of an object or of an image or other data set derived from the object.

As used herein, certain fiducials (e.g., linear fiducials) may be described or otherwise characterized as constituting a grouping or arrangement of features (e.g., sample sites, such as sample wells or nanowells) as well as “blanks” or “blank regions” where a well may be expected (based on an underlying or implied pattern of sites) but was not formed or where a well is present, but empty of sample (i.e., a “dark” well)) which when considered together or in the aggregate form a fiducial that is optically discernible from a pattern associated with non-fiducial regions. In certain embodiments discussed herein, the sample sites present in the linear fiducial may be elongated relative to non-fiducial sample sites, such as spanning two, three, or more site locations with respect to the underlying and shared pattern of sites (e.g., a hexagonal or rectilinear pattern). Thus, in certain embodiments discussed herein a fiducial may comprise a combination of sample sites (elongated or otherwise) and “blank” regions. By way of example, in various embodiments discussed herein a fiducial (e.g., a linear fiducial) may comprise a full row of sample sites between respective rows of “blank” sites or wells; a partial row of sample sites (e.g., alternating sample wells and “blanks”) between respective rows of “blank” sites or wells; or multiple rows, each row comprising both sample sites and “blanks” but in which every row has at least one sample site (i.e., there are no “site-free” rows within the fiducial). Conversely, in other embodiments a fiducial (e.g., a linear fiducial) may comprise elongated sample sites with one or both of blanks or non-elongated sample sites (e.g., as found in the non-fiducial regions of the substrate).

Several examples will be described herein with respect to fiducials, their form, their configuration, and their use in systems and methods of analysis. It will be understood that systems are also provided for carrying out the methods in an automated or semi-automated way, and such systems will include a processor; a data storage device; and a program for image analysis, the program including instructions for carrying out one or more methods provided for processing or leveraging fiducial data, such as image registration, distortion correction, and so forth. Accordingly, methods discussed herein can be carried out on a computer, for example, having components and executable routines needed for such purposes.

The methods and systems described herein may be employed for analyzing any of a variety of materials, such as biological samples and molecules, which may be on or in a variety of objects. Useful objects are solid supports or solid-phase surfaces with attached analytes. The methods and systems set forth may provide advantages when used with objects having a repeating pattern of features in an x, y plane, such as a patterned flow cell having an attached collection of molecules, such as DNA, RNA, biological material from viruses, proteins, antibodies, carbohydrates, small molecules (such as drug candidates), biologically active molecules, or any other analytes of interest.

An increasing number of applications have been developed for substrates with patterned arrangements of features (e.g., sample wells or sites) having biological molecules, such as nucleic acids and polypeptides. Such patterned features may include DNA or RNA probes. These are specific for nucleotide sequences present in plants, animals (e.g., humans), and other organisms. In some applications, for example, individual DNA or RNA probes can be attached at individual features (e.g., sample wells or sites) of a surface of a patterned flow cell. A test sample, such as from a known or unknown person or organism, can be exposed to the sites, such that target nucleic acids (e.g., gene fragments, mRNA, or amplicons thereof) hybridize to complementary probes at respective sites in the pattern of sites. The probes can be labeled in a target specific process (e.g., due to labels present on the target nucleic acids or due to enzymatic labeling of the probes or targets that are present in hybridized form at the features). The patterned surface can then be examined, such as by scanning specific frequencies of light over the features to identify which target nucleic acids are present in the sample.

Patterned flow cells may be used for genetic sequencing and similar applications. In general, genetic sequencing includes determining the order of nucleotides in a length of target nucleic acid, such as a fragment of DNA or RNA. Relatively short sequences may be sequenced at each feature, and the resulting sequence information may be used in various bioinformatics methods to logically fit the sequence fragments together, so as to reliably determine the sequence of much more extensive lengths of genetic material from which the fragments are available. Automated, processor-executable routines for characterizing fragments may be employed, and have been used in endeavors such as genome mapping, identification of genes and their function, and so forth. Patterned arrangements of sample sites on a surface are useful for characterizing genomic content because a large number of variants may be present and this supplants the alternative of performing many experiments on individual probes and targets. Thus, the patterned surface (such as a patterned surface of a flow cell) may be a useful platform for performing such investigations in a practical manner.

As noted above, any of a variety of patterned surface (e.g., patterned flow cells) having sample binding sites or wells can be used in a method or system set forth herein. Such patterned surface may contain features, each having an individual probe or a population of probes. In the latter case, the population of probes at each feature may be homogenous having a single species of probe. For example, in the case of a nucleic acid sequencing flow cell, each sample well or site can have multiple nucleic acid molecules each having a common sequence. However, in some other examples, the populations at each site or well of a patterned surface can be heterogeneous. Similarly, protein based patterned surfaces can have features with a single protein or a population of proteins, which may or may not have the same amino acid sequence. The probes can be attached to the patterned surface, for example, via covalent linkage of the probes to the surface or via non-covalent interaction of the probes with the surface. In some examples, probes, such as nucleic acid molecules, can be attached to a surface via a gel layer as described, for example, in U.S. Pat. No. 9,012,022 and U.S. Pat. App. Pub. No. 2011/0059865 A1, each of which is incorporated herein by reference in its entirety for all purposes.

Patterned surfaces used for nucleic acid sequencing often have random spatial patterns of nucleic acid features. For example, HiSeq™ or MiSeq™ sequencing platforms available from Illumina Inc. utilize flow cells comprising supports (e.g., surfaces) upon which nucleic acid(s) is/are disposed by random seeding followed by bridge amplification. However, patterned surfaces (upon which discrete reaction sites are formed in a pattern on the surface) can also be used for nucleic acid sequencing or other analytical applications. Example patterned surfaces, methods for their manufacture and methods for their use are set forth in U.S. Pat. Nos. 9,512,422; 8,895,249; and 9,012,022; and in U.S. Pat. App. Pub. Nos. 2013/0116153 A1; and 2012/0316086 A1, each of which is incorporated herein by reference in its entirety. The features (e.g., reaction or capture sites or wells) of such patterned surfaces can be used to capture a single nucleic acid template molecule to seed subsequent formation of a homogenous colony, for example, via bridge amplification. Such patterned surfaces are useful for nucleic acid sequencing applications.

The size of features, such as reaction or sample binding sites (e.g., sample wells or nanowells) on a patterned surface (or another object used in a method or system herein), can be selected to suit a desired application. In some non-limiting examples, a feature of a patterned surface can have a size that accommodates only a single nucleic acid molecule. A surface having a plurality of features in this size range is useful for constructing a pattern of molecules for detection at single molecule resolution. Features in this size range are also useful in patterned surfaces having features that each contain a colony of nucleic acid molecules. Thus, the features of a patterned surface can each have an area that is no larger than about 1 mm², no larger than about 500 μm², no larger than about 100 μm², no larger than about 10 μm², no larger than about 1 μm², no larger than about 500 nm², no larger than about 100 nm², no larger than about 10 nm², no larger than about 5 nm², or no larger than about 1 nm². Alternatively or additionally, the features of a patterned surface will be no smaller than about 1 mm², no smaller than about 500 μm², no smaller than about 100 μm², no smaller than about 10 μm², no smaller than about 1 μm², no smaller than about 500 nm², no smaller than about 100 nm², no smaller than about 10 nm², no smaller than about 5 nm², or no smaller than about 1 nm². Indeed, a feature can have a size that is in a range between an upper and lower limit selected from those exemplified above. Although several size ranges for features of a surface have been exemplified with respect to nucleic acids and on the scale of nucleic acids, it will be understood that features in these size ranges can be used for applications that do not include nucleic acids. It will be further understood that the size of the features need not necessarily be confined to a scale used for nucleic acid applications.

For examples that include an object (e.g., a flow cell surface) having a plurality of features, the features can be discrete, being separated with spaces between each other. A patterned surface useful in the present context can have features that are separated by edge to edge distance of at most about 100 μm, about 50 μm, about 10 μm, about 5 μm, about 1 μm, about 0.5 μm, or less. Alternatively or additionally, a patterned surface can have features that are separated by an edge to edge distance of at least about 0.5 μm, about 1 μm, about 5 μm, about 10 μm, about 50 μm, about 100 μm, or more. These example ranges are provided by way of context, are non-limiting, and can apply to the average edge to edge spacing for features, as well as to the minimum or maximum spacing.

The size of the features and/or pitch of the features can vary such that the features on a patterned surface can have a desired density. For example, the average feature pitch in a regular pattern can be at most about 100 μm, about 50 μm, about 10 μm, about 5 μm, about 1 μm, about 0.5 μm, or about 350 nm, or less. Alternatively or additionally, the average feature pitch in a regular pattern can be at least about 0.5 μm, about 1 μm, about 5 μm, about 10 μm, about 50 μm, or about 100 μm or more. These ranges can apply to the maximum or minimum pitch for a regular pattern as well. For example, the maximum feature pitch for a regular pattern can be at most about 100 μm, about 50 μm, about 10 μm, about 5 μm, about 1 μm, or about 0.5 μm or less; and/or the minimum feature pitch in a regular pattern can be at least about 0.5 μm, about 1 μm, about 5 μm, about 10 inn, about 50 inn, or about 100 μm or more.

The density of features on a patterned surface can also be understood in terms of the number of features present per unit area. For example, the average density of features on a patterned surface can be at least about 1×10³ features/mm², about 1×10⁴ features/mm², about 1×10⁵ features/mm² about 1×10⁶ features/mm², about 1×10⁷ features/mm², about 1×10⁸ features/mm², or about 1×10⁹ features/mm² or higher. Alternatively or additionally, the average density of features on a patterned surface can be at most about 1×10⁹ features/mm², about 1×10⁸ features/mm², about 1×10⁷ features/mm², about 1×10⁶ features/mm², about 1×10⁵ features/mm², about 1×10⁴ features/mm², or about 1×10³ features/mm² or less.

The features provided on a patterned surface can have any of a variety of shapes, cross-sections, and layouts. For example, when observed in a two dimensional plane, such as on a surface, the features can have a perimeter that is rounded, circular, oval, rectangular, square, symmetric, asymmetric, triangular, polygonal, or the like. The features can be arranged in a regular repeating pattern including, for example, a hexagonal or rectilinear pattern. A pattern can be selected to achieve a desired level of packing. For example, round features are optimally packed in a hexagonal arrangement. Other packing arrangements can also be used for round features and vice versa.

In general, a patterned surface might be characterized in terms of the number of features that are present in a subset that forms the smallest geometric unit of the pattern. The subset can include, for example, at least 2, 3, 4, 5, 6, 10 or more features. Depending upon the size and density of the features, the geometric unit can occupy an area of less than about 1 mm², about 500 μm², about 100 μm², about 50 μm², about 10 μm², about 1 μm², about 500 nm², about 100 nm², about 50 nm², or about 10 nm² or less. Alternatively or additionally, the geometric unit can occupy an area of greater than about 10 nm², about 50 nm², about 100 nm², about 500 nm², about 1 μm², about 10 μm², about 50 μm², about 100 μm², about 500 μm², or about 1 mm² or more. Characteristics of the features in a geometric unit, such as shape, size, pitch and the like, can be selected from those set forth herein more generally with regard to features provided on a patterned surface.

A surface having a regular pattern of features can be ordered with respect to the relative locations of the features but random with respect to one or more other characteristic of each feature. For example, in the case of a nucleic acid sequencing surface, the nucleic acid features can be ordered with respect to their relative locations but random with respect to one's knowledge of the sequence for the nucleic acid species present at any feature. As a more specific example, nucleic acid sequencing surfaces formed by seeding a repeating pattern of features with template nucleic acids and amplifying the template at each feature to form copies of the template at the feature (e.g., via cluster amplification or bridge amplification) will have a regular pattern of nucleic acid features but will be random with regard to the distribution of sequences of the nucleic acids across the pattern. Thus, detection of the presence of nucleic acid material on the surface can yield a repeating pattern of features, whereas sequence specific detection can yield non-repeating distribution of signals across the surface.

As may be appreciated, the description of patterns, order, randomness and so forth provided herein not only pertains to features on objects (e.g., a solid substrate having such features, such as features on solid-supports or surface), but also to image data, or images generated from such image data, that includes or depicts such an object having features as described herein. As such, patterns, order, randomness and so forth can be present in any of a variety of formats that are used to store, manipulate or communicate image data including, but not limited to, a computer readable medium or computer component such as a graphical user interface or other output device.

As discussed above and throughout, patterned flow cells have a regular pattern of sample sites (e.g., wells or nanowells) imprinted in the surfaces of the flow cell. This pattern is normally hexagonal or square, and can have different orientations. In practice, a hexagonal pattern is conventionally used in current systems that employ a linear scanning imaging system. In such contexts, the hexagonal pattern may typically have one axis aligned at right angles to the scanning direction. This axis is typically referred to as “horizontal” due to how images are normally presented with the image vertical axis being aligned with the scanning direction. Location of the individual wells is typically made possible by using fiducials in known locations on the flow cell pattern.

In conventional approaches, certain fiducials, which may be referred to herein as conventional or coarse-alignment fiducials, may be in the form of a “bullseye” pattern consisting of concentric dark and bright circles. Each image scanned from the flow cells (each image typically referred to as a “tile” or “image tile”) may have from 4 to 8 bullseye fiducials on current platforms. The image data acquired of such “bullseye” fiducials is used in the generation of geometric transforms, such as affine transforms, that may be used to perform image corrections, such as to compensate for shifts, skews, and magnification changes along both principal axes of the image. The image data acquired of such “bullseye” fiducials, however, does not provide sufficient information for non-linear corrections of the image geometry, i.e., to identify and correct for deviations from linear movement of the sample relative to the imaging optics.

One method to detect transverse movements of the scanning mechanism (e.g., linear motion deviations) employees one-dimensional (1-D) Fourier transforms of the well pattern on the flow cell. This may be accomplished by detecting the phase of the peaks in the Fourier transform corresponding to the period of the well pattern. There are, however, two issues which can affect the utility of this approach. First, the spacing (i.e., pitch) of the well pattern of the flow cell may be below the Shannon-Nyquist sampling limit for the optical system. By way of example, there may be less than 2 pixels in the image for each well location (e.g., 1.9 pixels/well). As a result, the period of the well pattern cannot be directly represented in the 1-D Fourier transform. However, by utilizing aliasing it is still possible to reliably detect phase for slightly or moderately undersampled data, thereby allowing accurate estimates of transverse movement in the x-direction.

However, to increase sample densities and, correspondingly, improve throughput and efficiency, there is an incentive to reduce the pitch of flow cells, such as to a flow cell pitch of 1.8 pixels/pitch or less (e.g., 1.7 pixel/pitch). The aliasing approach used to address slight and moderate undersampled data is not adequate to address this degree of undersampling.

A further issue relevant to hexagonal flow cell patterns is that alternate rows are offset by half a well distance relative to each other. As a result, some 1-D Fourier transforms lose signal where the pixel row spans two rows of sample wells on the flow cell.

With these issues in mind, various fiducials, referred to herein as linear fiducials, are described herein that may be used to address one or both of these concerns. In the linear fiducials discussed herein, multiple well locations may be “blanked” out so as to create breaks in the overall pattern of well sites. By way of example, a fiducial pattern may comprise three rows of wells over a central location in the flow cell (e.g., centered with respect to an x-axis or other axis), with wells in the two outer rows blanked out. In this manner, the issues arising from alternating well locations on adjacent rows may be addressed by the fiducial. In a second aspect of one such implementation, alternating wells in the center row of wells are also blanked out. In this manner, the effective pitch in the fiducial is increased such that the well pitch in this fiducial pattern will not be affected the Shannon-Nyquist limit, thereby allowing tighter pixel pitches to be used overall within the flow cell.

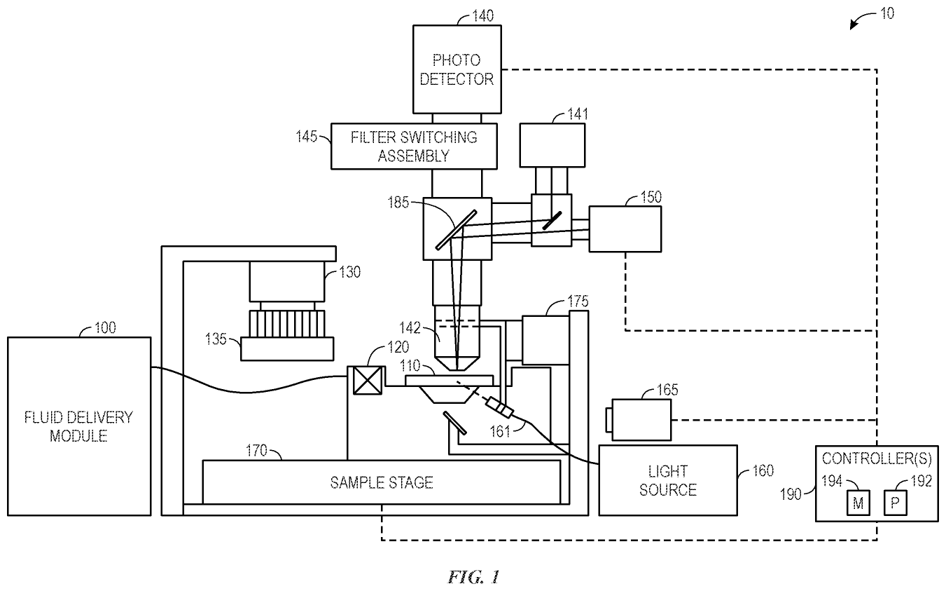

While the preceding provides useful background and context with respect to terminology and processes, the following provides an example of suitable systems and functional workflows that may utilize or process sample substrates having fiducials as described herein. By way of example, FIG. 1 depicts an example of an optical image scanning system 10, such as a sequencing system, that may be used in conjunction with the disclosed fiducials and corresponding registration techniques to process biological samples. With respect to such an imaging system 10, it may be appreciated that such imaging systems typically include a sample stage or support that holds a sample or other object to be imaged (e.g., a flow cell or sequencing cartridge having a patterned surface of spaced apart sample sites, such as sample wells) and an optical stage that includes the optics used for the imaging operations.

Turning to FIG. 1, the example imaging scanning system 10 may include a device for obtaining or producing an image of a region, such as an image tile, sub-tile, or line of a flow cell. The example illustrated in FIG. 1 shows an example image scanning system configured in a backlit operational configuration. In the depicted example, subject samples are located on sample container 110 (such as a flow cell), which is positioned on a sample stage 170 under an objective lens 142. Light source 160 and associated optics direct a beam of light, such as laser light, to a chosen sample location on the sample container 110. The sample fluoresces and the resultant light is collected by the objective lens 142 and directed to a photodetector 140 to detect the florescence. Sample stage 170 is moved relative to objective lens 142 to position the next sample location on sample container 110 at the focal point of the objective lens 142. Movement of sample stage 170 relative to objective lens 142 can be achieved by moving the sample stage itself, the objective lens, the entire optical stage, or any combination of these structures. Further examples may also include moving the entire imaging system over a stationary sample.

A fluid delivery module or device 100, as discussed in greater detail below, directs a flow of reagents (e.g., fluorescent nucleotides, buffers, enzymes, cleavage reagents, etc.) to (and through) the sample container 110 and waste valve 120. In some applications, the sample container 110 can be implemented as a flow cell that includes clusters of nucleic acid sequences at a plurality of sample locations on the sample container 110. The samples to be sequenced may be attached to the substrate of the flow cell, along with other optional components. In practice, the plurality of sample locations provided on a surface of the flow cell may be arranged as spaced apart sample sites (e.g., wells or nanowells), which in turn may be subdivided into tile, sub-tile, and line regions each comprising a corresponding subset of the plurality of sample locations.

The depicted example image scanning system 10 also comprises temperature station actuator 130 and heater/cooler 135 that can optionally regulate the temperature or conditions of the fluids within the sample container 110. A camera system (e.g., photodetector system 140) can be included to monitor and track the sequencing of sample container 110. The photodetector system 140 can be implemented, for example, as a CCD camera, which can interact with various filters within filter switching assembly 145, objective lens 142, and focusing laser assembly (e.g., focusing laser 150 and focusing detector 141). The photodetector system 140 is not limited to a CCD camera and other cameras and image sensor technologies can be used.

Light source 160 (e.g., an excitation laser within an assembly optionally comprising multiple lasers) or another light source can be included to illuminate fluorescent sequencing reactions within the samples via illumination through a fiber optic interface 161 (which can optionally comprise one or more re-imaging lenses, a fiber optic mounting, etc.). Low watt lamp 165 and reverse dichroic 185 are also presented in the example shown. In some applications focusing laser 150 may be turned off during imaging. In other applications, an alternative focus configuration can include a second focusing camera, which can be a quadrant detector, a position sensitive detector, or similar detector to measure the location of the scattered beam reflected from the surface concurrent with data collection.

Although illustrated as a backlit device, other examples may include a light from a laser or other light source that is directed through the objective lens 142 onto the samples on sample container 110 (i.e., a frontlit configuration). Sample container 110 can be mounted on a sample stage 170 to provide movement and alignment of the sample container 110 relative to the objective lens 142. The sample stage 170 can have one or more actuators to allow it to move in any of three directions. For example, in terms of the Cartesian coordinate system, actuators can be provided to allow the stage to move in the x-, y- and z-directions relative to the objective lens 142. This can allow one or more sample locations on sample container 110 to be positioned in optical alignment with objective lens 142.

A focus component 175 is shown in this example as being included to control positioning of the optical components relative to the sample container 110 in the focus direction (typically referred to as the z-axis, or z-direction). Focus component 175 can include one or more actuators physically coupled to the optical stage or the sample stage, or both, to move sample container 110 on sample stage 170 relative to the optical components (e.g., the objective lens 142) to provide proper focusing for the imaging operation. For example, the actuator may be physically coupled to the respective stage such as, for example, by mechanical, magnetic, fluidic or other attachment or contact directly or indirectly to or with the stage. The one or more actuators can be configured to move the stage in the z-direction while maintaining the sample stage in the same plane (e.g., maintaining a level or horizontal attitude, perpendicular to the optical axis). The one or more actuators can also be configured to tilt the stage. This can be done, for example, so that sample container 110 can be leveled dynamically to account for any slope in its surfaces.

Focusing of the system generally refers to aligning the focal plane of the objective lens 142 with the sample to be imaged at the chosen sample location. However, focusing can also refer to adjustments to the system to obtain or enhance a desired characteristic for a representation of the sample such as, for example, a desired level of sharpness or contrast for an image of a test sample. Because the usable depth of field of the focal plane of the objective lens 142 may be very small (sometimes on the order of 1 μm or less), focus component 175 closely follows the surface being imaged. Because the sample container may not be perfectly flat as fixtured in the instrument, focus component 175 may be set up to follow this profile while moving along in the scanning direction (typically referred to as the y-axis).

The light emanating from a test sample at a sample location being imaged can be directed to one or more photodetectors 140. Photodetectors can include, for example a CCD camera. An aperture can be included and positioned to allow only light emanating from the focus area to pass to the photodetector(s). The aperture can be included to improve image quality by filtering out components of the light that emanate from areas that are outside of the focus area. Emission filters can be included in filter switching assembly 145, which can be selected to record a determined emission wavelength and to block any stray laser light.

In various examples, sample container 110 (e.g., a flow cell) can include one or more substrates upon which the samples are provided. For example, in the case of a system to analyze a large number of different nucleic acid sequences, sample container 110 can include one or more substrates on which nucleic acids to be sequenced are bound, attached or associated. In various examples, the substrate can include any inert substrate or matrix to which nucleic acids can be attached, such as for example glass surfaces, plastic surfaces, latex, dextran, polystyrene surfaces, polypropylene surfaces, polyacrylamide gels, gold surfaces, and silicon wafers. In some applications, the substrate is within a channel or other area at a plurality of locations formed in a matrix or pattern across the sample container 110.

One or more controllers 190 (e.g., processor or ASIC based controller(s)) can be provided to control the operation of a scanning system, such as the example image scanning system 10 described with reference to FIG. 1. The controller 190 can be implemented to control aspects of system operation such as, for example, focusing, stage movement, and imaging operations. In various applications, the controller can be implemented using hardware, software, or a combination of the preceding. For example, in some implementations the controller can include one or more CPUs or processors 192 with associated memory 194. As another example, the controller can comprise hardware or other circuitry to control the operation. For example, this circuitry can include one or more of the following: field programmable gate arrays (FPGA), application specific integrated circuits (ASIC), programmable logic devices (PLD), complex programmable logic devices (CPLD), a programmable logic array (PLA), programmable array logic (PAL), or other similar processing device or circuitry. As yet another example, the controller can comprise a combination of this circuitry with one or more processors.

Although acquisition and registration of image data of arrangements of features (e.g., sample sites, such as wells) for use as fiducials may be described and discussed herein in the context of this example system, this is only one example with which these techniques might be implemented. After reading this description, one of ordinary skill in the art will understand how the systems and methods described herein can be implemented with this and other scanners, microscopes and other imaging systems.

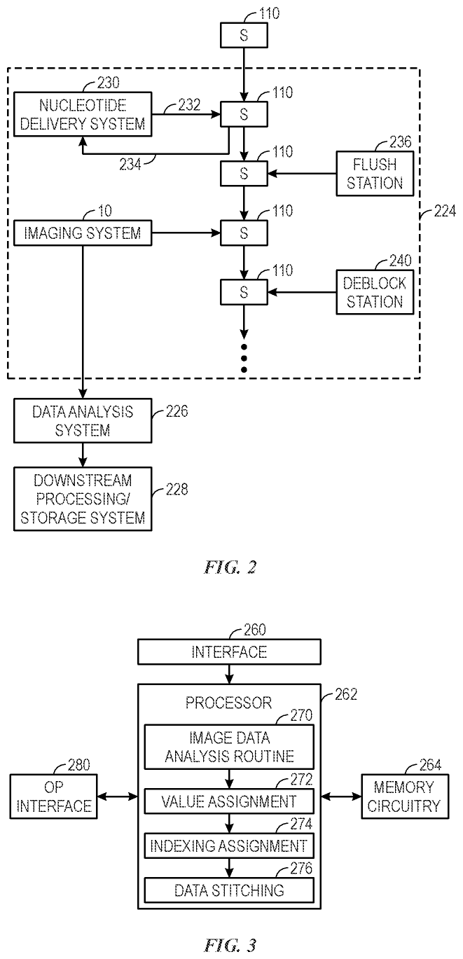

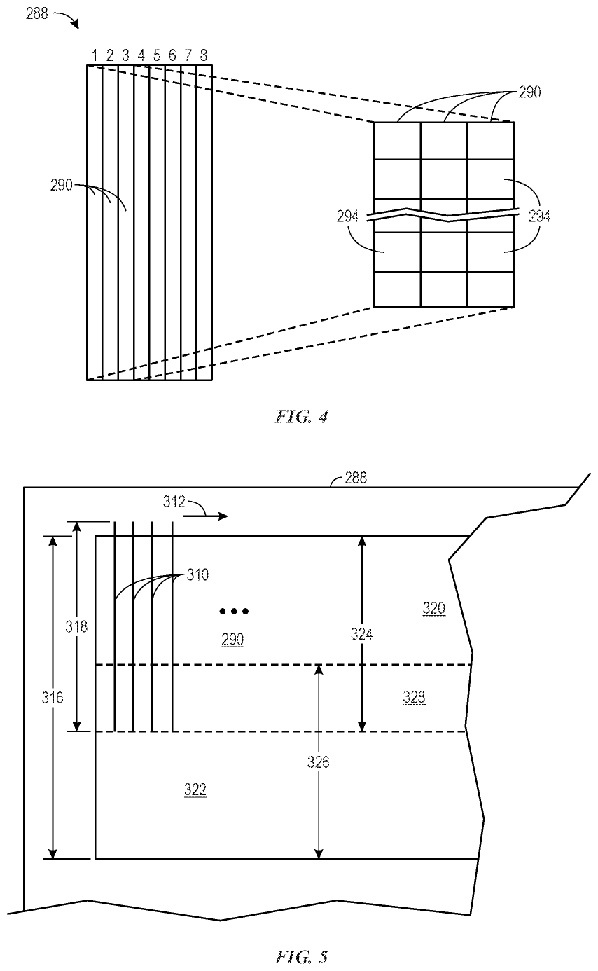

While the preceding description covers aspects of an optical image scanning system 10, such as a sequencing system, FIGS. 2 and 3 discuss the use of such a system 10 in the context of a functional work flow. This discussion is provided in order to provide useful, real-world context for the subsequent discussion of fiducials, such as linear fiducials used in the detection and correction of deviation from a linear scan path. In this manner, it is hoped that the use and significance of the fiducials and their use in the approaches subsequently described will be more fully appreciated.

With this in mind, and turning to FIG. 2, a block diagram illustrating an example work flow in conjunction with system components is provided. In this example, the work flow and corresponding system components may be suitable for processing patterned flow cells (such as for biological applications), imaging the patterned flow cell surface, and analyzing data derived from the imaging.

In the illustrated example, molecules (such as nucleotides, oligonucleotides, and other bioactive reagents) may be introduced into respective sample container 110 that may be prepared in advance. As noted herein, such sample containers 110 may comprise flow cells, sequencing cartridges, or other suitable structures having substrates encompassing sample sites for imaging. The depicted work flow with system components may be utilized for synthesizing biopolymers, such as DNA chains, or for sequencing biopolymers. However, it should be understood that the present technique is not limited to sequencing operations, gene expression operations, diagnostic applications, and so forth, but may be used more generally for analyzing collected image data for multiple lines, swaths or regions detected from imaging of a sample or sample holder, as described below. Other substrates containing reaction or capture sites for molecules or other detectable features can similarly be used with the techniques and systems disclosed.

In the present context, example biopolymers may include, but are not limited to, nucleic acids, such as DNA, RNA, or analogs of DNA or RNA. Other example biopolymers may include proteins (also referred to as polypeptides), polysaccharides, or analogs thereof. Although any of a variety of biopolymers may be processed in accordance with the described techniques, to facilitate and simplify explanation the systems and methods used for processing and imaging in the example context will be described with regard to the processing of nucleic acids. In general, the described work flow will process sample containers 110, each of which may include a patterned surface of reaction sites. As used herein, a “patterned surface” refers to a surface of a support or substrate having a population of different discrete and spaced apart reaction sites, such that different reaction sites can be differentiated from each other according to their relative location. A single species of biopolymer may be attached to each individual reaction site. However, multiple copies of a species of biopolymer can be attached to a reaction site. The pattern, taken as a whole, may include a plurality of different biopolymers attached at a plurality of different sites. Reaction sites can be located at different addressable locations on the same substrate. Alternatively, a patterned surface can include separate substrates each forming a different reaction site. The sites may include fragments of DNA attached at specific, known locations, or may be wells or nanowells in which a target product is to be synthesized. In some applications, the system may be designed for continuously synthesizing or sequencing molecules, such as polymeric molecules based upon common nucleotides.

In the diagrammatical representation of FIG. 2, an analysis system may include a processing system 224 (e.g., a sequencing system or station) designed to process samples provided within sample containers 110 (such as may include biological patterned surfaces), and to generate image data representative of individual sites on the patterned surface, as well as spaces between sites, and representations of fiducials provided in or on the patterned surface. A data analysis system 226 receives the image data and processes the image data in accordance with the present disclosure to extract meaningful values from the imaging data as described herein. A downstream processing/storage system 228, then, may receive this information and store the information, along with imaging data, where desired. The downstream processing/storage system 228 may further analyze the image data or processed data derived from the image data, such as to diagnose physiological conditions, compile sequencing lists, analyze gene expression, and so forth.

With respect to the data analysis system 226 and/or the downstream process/storage system 228 as may be relevant to the present context, image data may be analyzed using a real-time analysis (RTA) protocol commercially available for Illumina sequencers. Fiducials may be formed and disposed as discussed below, such as in or partially within swaths of sites. Dark (non-signal producing regions or pixels) and light (signal producing regions or pixels) areas may be assigned an intensity level of 0 and 255, respectively, or any desired other level or levels between these. The data indicating the presence of a fiducial may be cross correlated at possible x- and y-offsets and shifted to maximize correlation. An area may be fit, for example to a two-dimensional Gaussian to determine a subpixel x- and y-shift that maximizes the cross correlation. This process can be repeated in different regions of the image where the fiducials are located. The subpixel x- and y-offsets determined in each region may be used to determine a geometric transform or set of geometric transforms describing how features on the designed patterned surface appear in the image data By way of example, an Affine transform or Projective transform may be derived in this manner. In particular embodiments discussed herein, certain of the fiducials, i.e., linear fiducials, may be used to determine if there is deviation from linear motion in real-time during a scanning operation and to allow for the correction of such detected deviation, either as one or both of a control-feedback loop to the mechanisms controlling motion of the sample stage and/or optics or as an image-based correction factor.

The processing system 224 may employ a biomolecule reagent delivery system (shown as a nucleotide delivery system 230 in the example of FIG. 2) for delivering various reagents to a sample container 110 as processing progresses. The biomolecule reagent delivery system may correspond to the fluid delivery module or device 100 of FIG. 1. Processing system 224 may perform a plurality of operations through which sample container 110 and corresponding samples progress. This progression can be achieved in a number of ways including, for example, physical movement of the sample container 110 to different stations, or loading of the sample container 110 (such as a flow cell) in a system in which the sample container 110 is moved or an optical system is moved, or both, or the delivery of fluids is performed via valve actuation. A system may be designed for cyclic operation in which reactions are promoted with single nucleotides or with oligonucleotides, followed by flushing, imaging, and de-blocking in preparation for a subsequent cycle. In a practical system, the sample containers 110 and corresponding samples are disposed in the processing system 224 and an automated or semi-automated sequence of operations is performed for reactions, flushing, imaging, de-blocking, and so forth, in a number of successive cycles before all useful information is extracted from the test sample. Again, it should be noted that the work flow illustrated in FIG. 2 is not limiting, and the present techniques may operate on image data acquired from any suitable system employed for any application. It should be noted that while reference is made in the present disclosure to “imaging” or “image data”, in many practical systems this will entail actual optical imaging and extraction of data from electronic detection circuits (e.g., cameras or imaging electronic circuits or chips), although other detection techniques may also be employed, and the resulting electronic or digital detected data characterizing the molecules of interest should also be considered as “images” or “image data”.

In the example illustrated in FIG. 2, the nucleotide delivery system 230 provides a process stream 232 to the sample containers 110. An effluent stream 234 from the sample containers 110 (e.g., a flow cell) may be recaptured and recirculated, for example, in the nucleotide delivery system 230. In the illustrated example, the patterned surface of the flow cell may be flushed at a flush station 236 (or in many cases by flushing by actuation of appropriate valving, such as waste valve 120 of FIG. 1) to remove additional reagents and to clarify the sample within the sample containers 110 for imaging. The sample containers 110 is then imaged, such as using line imaging or area imaging techniques, by an imaging system 10 (which may be within the same device). The image data thereby generated may be analyzed, for example, for determination of the sequence of a progressively building nucleotide chain, such as based upon a template. In one possible embodiment, the imaging system 10 may employ confocal line scanning to produce progressive pixilated image data that can be analyzed to locate individual sites on the patterned surface and to determine the type of nucleotide that was most recently attached or bound to each site. Other imaging techniques may also suitably be employed, such as techniques employing “step and shoot” or other area-based imaging approaches.

As noted, the imaging components of the imaging system 10 may be more generally considered a “detection apparatus”, and any detection apparatus that is capable of high resolution imaging of surfaces may be employed. In some examples, the detection apparatus will have sufficient resolution to distinguish features at the densities, pitches and/or feature sizes set forth herein. Examples of the detection apparatus are those that are configured to maintain an object and detector in a static relationship while obtaining a line or area image. As noted, a line scanning apparatus can be used, as well as systems that obtain continuous or successive area images (e.g. “step and shoot” detectors). Line scanning detectors can be configured to scan a line along the y-dimension of the surface of an object, where the longest dimension of the line occurs along the x-dimension. It will be understood that the detection device, object, or both can be moved to achieve scanning detection. Detection apparatuses that are useful, for example in nucleic acid sequencing applications, are described in U.S. Pat. App. Pub. Nos. 2012/0270305 A1; 2013/0023422 A1; and 2013/0260372 A1; and U.S. Pat. Nos. 5,528,050; 5,719,391; 8,158,926 and 8,241,573, all of which are incorporated herein by reference in their entirety for all purposes.

In one example, an imaging system 10 that is used in a method or system set forth herein may scan along the y-dimension of a patterned surface, scanning parallel swaths of sites of the patterned surface in the process. The patterned surface may include coarse-alignment markers that distinguish the relative locations of the swaths of sites along the x-dimension. When used, the coarse-alignment markers can cooperate with the detection apparatus, such as to determine the location of at least one of the swaths of sites. Optionally, the relative position of the detection apparatus and/or the sample container 110 having the patterned surface may be adjusted based on the location determined for the swaths. In some examples, the determining of the location of the swaths can be performed by an algorithm by a processor or computer, such as a computer used to perform registration or feature identification. Thus, the system may function to perform the algorithm on the computer to determine locations for the features in the image data, as well as to characterize molecules at each site, referenced based on the fiducials.

Following imaging (e.g., at imaging system 10), the sample container 110 may progress to a deblock station 240 for de-blocking, during which a blocking molecule or protecting group is cleaved from the last added nucleotide, along with a marking dye. If the processing system 224 is used for sequencing, by way of example, image data from the imaging system 10 will be stored and forwarded to a data analysis system 226.

The data analysis system 226 may include a general purpose or application-specific programmed computer, which provides a user interface and automated or semi-automated analysis of the image data to determine which of the four common DNA nucleotides may have been last added at each of the sites on a patterned surface, as described below. As will be appreciated by those skilled in the art, such analysis may be performed based upon the color of unique tagging dyes for each of the four common DNA nucleotides. This image data may be further analyzed by the downstream processing/storage system 228, which may store data derived from the image data as described below, as well as the image data itself, where appropriate. Again, the sequencing application is intended to be one example, and other operations, such as diagnostic applications, clinical applications, gene expression experiments, and so forth may be carried out that will generate similar imaging data operated on by the present techniques.

As noted above, in some implementations, the sample container 110 (e.g., a flow cell) having the patterned surface may remain in a fixed or substantially fixed position, and the “stations” referred to may include integrated subsystems that act on the sample container 110 as described (e.g., for introduction and reaction with desired chemistries, flushing, imaging, image data collection, and so forth). The data analysis may be performed contemporaneously with the other processing operations (i.e., in “real time”), or may be done post-processing by accessing the image data, or data derived from the image data, from an appropriate memory (in the same system, or elsewhere). In many applications, a patterned surface “container” will comprise a cartridge or flow cell in which the patterned surface exists and through which the desired chemistry is circulated. In such applications, imaging may be done through and via the flow cell. The flow cell may be appropriately located (e.g., in the x-y plane), and moved (e.g., in x-, y-, and z-directions) as needed for imaging. Connections for the desired chemistry may be made directly to the flow cell when it is mounted in the apparatus. Moreover, depending upon the device design and the imaging technique used, the patterned surface, encased in the flow cell, may be initially located in the x-y plane, and moved in this plane during imaging, or imaging components may be moved parallel to this plane during imaging. In general, here again, the “x-y plane” is the plane of the patterned surface that supports the sites, or a plane parallel to this. The flow cell, therefore, may be said to extend in the x-y plane, with the x-direction being the longer direction of the flow cell, and the y-direction being the shorter direction (the flow cells being rectangular). It is to be understood, however, that this orientation could be reversed. The flow cell and corresponding patterned surface may also be moved in the z-direction, which is the focus-direction, typically orthogonal to both the x- and y-directions. Such movements may be useful for securing the flow cell into place, for making fluid connections to the flow cell, and for imaging (e.g., focusing the optic for imaging sites at precise z-depths). In some applications, the optic may be moved in the x-direction for precise imaging.

FIG. 3 illustrates an example data analysis system 226 and some of its functional components that may be relevant to the present approach. As noted above, the data analysis system 226 may include one or more programmed computers, with programming being stored on one or more machine readable media with code executed to carry out the processes described. Alternatively or in addition, one or more application specific integrated circuits (ASICs) and/or field programmable gate arrays (FPGAs) (or other hardware based solutions) may be employed to perform some or all of the functionality attributed to the data analysis system 226 as described herein. In the illustrated example, the data analysis system 226 includes an interface 260 designed to permit networking of the data analysis system 226 to one or more imaging systems 10 acquiring image data of patterned surfaces of reaction or capture sites (i.e., features, such as wells) within a sample container 110. The interface 260 may receive and condition data, where appropriate. In general, however, the imaging system 10 will output digital image data representative of individual picture elements or pixels that, together, form an image of the patterned surface (or a portion (e.g., line or tile) of it). In the depicted example, a processor 262 processes the received image data in accordance with a plurality of routines defined by processing code. The processing code may be stored in various types of memory circuitry 264. As used in this disclosure, the term “machine readable” means detectable and interpretable by a machine, such as a computer, processor, or a computer or processor in cooperation with detection and signal interpretation devices or circuits (e.g., computer memory and memory access components and circuits, imaging or other detection apparatus in cooperation with image or signal interpretation and processing components and circuits), and so forth.

Computers and processors useful for the present techniques may include specialized (e.g., application-specific) circuitry and/or general purpose computing devices, such as a processor that is part of a detection device, networked with a detection device used to obtain the data that is processed by the computer, or separate from the detection device. In some examples, information (e.g., image data) may be transmitted between components of a data analysis system 226 disclosed herein directly or via a computer network. A Local Area Network (LAN) or Wide Area Network (WAN) may be a corporate computing network, including access to the Internet, to which computers and computing devices comprising the data analysis system 226 are connected. In one example, the LAN conforms to the Transmission Control Protocol/Internet Protocol (TCP/IP) industry standard. In some instances, the information (e.g., image data) is input to a data analysis system 226 disclosed herein via an input device (e.g., disk drive, compact disk player, USB port, etc.). In some instances, the information is received by loading the information, such as from a storage device such as a disk or flash drive.

As noted above, in some examples, the processing circuitry may process image data in real or near-real time while one or more sets of image data of the support, sites, molecules, etc. are being obtained. Such real time analysis is useful for nucleic acid sequencing applications where an imaged surface having attached of nucleic acids is subjected to repeated cycles of fluidic and detection operations. Further, as discussed herein, such real-time analysis is particularly beneficial to detect deviations from linear motion during image acquisition so as to allow appropriate corrective actions to be performed. As noted herein, for features that are sufficiently small in scale (e.g., spanning less than two or three pixels, such deviations from linearity may have significant downstream processing consequences. Analysis of the sequencing data can often be computationally intensive such that it can be beneficial to perform the methods in real or near-real time or in the background while other data acquisition or analysis algorithms are in process. Example real time analysis methods that can be used with the present methods are those used for the MiSeq™ and HiSeq™ sequencing devices commercially available from Illumina, Inc. and/or described in U.S. Pat. App. Pub. No. 2012/0020537 A1, which is incorporated herein by reference in its entirety for all purposes. The terms “real time” and “near-real time”, when used in conjunction with the processing of samples and their imaging are intended to convey that the processing occurs at least in part during the time the samples are being processed and imaged (i.e., processing occurs simultaneously or contemporaneously with data acquisition). In other examples, image data may be obtained and stored for subsequent analysis by similar algorithms. This may permit other equipment (e.g., powerful processing systems) to handle the processing tasks at the same or a different physical site from where imaging is performed. This may also allow for re-processing, quality verification, and so forth.

In accordance with the presently contemplated examples, the processing code executed on the image data includes an image data analysis routine 270 designed to analyze the image data. Image data analysis may be used to determine the locations of individual sites visible or encoded in the image data, as well as locations in which no site is visible (i.e., where there is no site, or where no meaningful radiation was detected from an existing site). Image data analysis may also be used to determine locations of fiducials that aid in locating the sites.

As will be appreciated by those skilled in the art, in a biological patterned surface imaging context, respective sites of the patterned surface will appear brighter than non-site locations due to the presence of fluorescing dyes attached to the imaged molecules. It will be understood that the sites need not appear brighter than their surrounding area, for example, when a target for the probe at the site is not present in a sample being detected. The color at which individual sites appear may be a function of the dye employed, as well as of the wavelength range of the light used by the imaging system 28 for imaging purposes (e.g., the excitation wavelength range of light). Sites to which targets are not bound or that are otherwise devoid of a label can be identified according to other characteristics, such as their expected location on the patterned surface. Any fiducial markers may appear on one or more of the images, depending upon the design and function of the markers.

Once the image data analysis routine 270 has located individual sites in the image data, a value assignment may be carried out at step 272, often as a function of, or by reference to any fiducial markers provided. In general, the value assignment step 272 will assign a digital value to each site based upon characteristics of the image data represented by pixels at the corresponding location. That is, for example, the value assignment routine 272 may be designed to recognize that a specific color range or wavelength range of light was detected at a specific location within a threshold time after excitation, as indicated by a group or cluster of pixels at the location. The value assignment carried out at step 272 in such a context will assign the corresponding value to the entire site, alleviating the need to further process the image data itself, which will be much more voluminous (e.g., many pixels may correspond to each site) and of significantly larger numerical values (i.e., much larger number of bits to encode each pixel).

By way of further example, the present compositions, devices, and methods suitably can be used so as to generate luminescent images in sequencing-by-synthesis (SBS) techniques and devices. In such SBS approaches, a flow cell or other microfluidic device may include a sample and sample capture sites as described herein and one or more analytes may be flowed over the sites as part of a sequencing operation. A suitable number of luminophores may be employed that can be excited in sequence using any suitable number of excitation wavelengths. By way of example, four distinct excitation sources at four resonant wavelengths (λ₁, λ₂, λ₃, and λ₄) may be employed in a 4-channel SBS chemistry scheme, or two excitation wavelengths (λ₁ and λ₂) may be employed in a 2-channel SBS chemistry scheme, or one excitation wavelength (λ₁) may be employed in a 1-channel SBS chemistry scheme. Examples of 4-channel, 3-channel, 2-channel or 1-channel SBS schemes are described, for example, in US Pat. App. Pub. No. 2013/0079232 A1, which is hereby incorporated herein by reference in its entirety, and can be modified for use with the apparatus and methods set forth herein. As will be appreciated, in one such SBS approach for use in sequencing DNA using luminescent imaging, a first luminophore can be coupled to A, a second luminophore can be coupled to G, a third luminophore can be coupled to C, and a fourth luminophore can be coupled to T. As another example, in techniques for use in sequencing RNA using luminescent imaging, a first luminophore can be coupled to A, a second luminophore can be coupled to G, a third luminophore can be coupled to C, and a fourth luminophore can be coupled to U.

In practice, in a multi-channel system (e.g., a four-channel system) each respective sequencing-by-synthesis (SBS) cycle has an associated separate excitation and readout operation for each channel and each channel is separately read out each cycle. That is, for each SBS cycle in a four-channel system, there are four excitation and readout operations, each corresponding to a different channel. In a DNA imaging application, for example, the four common nucleotides may be represented by separate and distinguishable colors (or more generally, wavelengths or wavelength ranges of light), each color corresponding to a separate channel that is separately readout out during each SBS cycle.

An indexing assignment routine 274 associates each of the assigned values with a location in an image index or map, which may be made by reference to known or detected locations of fiducial markers, or to any data encoded by such markers. As described more fully below, the map will correspond to the known or determined locations of individual sites within the sample container 110. Data analysis routines (shown as data stitching step 276 in FIG. 3), which may be provided in the same or a different physical device, allows for identification or characterization of the molecules of the sample present within the sample container 110, as well as for logical analysis of the molecular data, where desired. For sequencing, for example, the data analysis routines may permit characterization of the molecules at each site by reference to the emission spectrum (that is, whether the site is detectable in an image, indicating that a tag or other mechanism produced a detectable signal when excited by a wavelength of light). The molecules at the sites, and subsequent molecules detected at the same sites may then be assembled logically into sequences. These short sequences may then be further analyzed by the data analysis routines 276 to determine probable longer sequences in which they may occur in the sample donor subject.

It may be noted that as in the illustration of FIG. 3, an operator (OP) interface 280 may be provided, which may consist of a device-specific interface, or in some applications, to a conventional computer monitor, keyboard, mouse, and so forth to interact with the routines executed by the processor 262. The operator interface 280 may be used to control, visualize or otherwise interact with the routines as imaging data is processed, analyzed and resulting values are indexed and processed.

FIG. 4 illustrates an example of a patterned surface 288 that may be present as part of or within a sample container 110. As shown in FIG. 4, a plurality of grids or swaths 290 (here depicted as vertical swaths) may be provided such that each includes a multitude of individual tiles 294 to be imaged. Each image tile 294 in turn comprises multitudes of sample sites (e.g., capture or reaction sites) which may display activity of interest at different cycles of a processing operation (e.g., a sequencing operation). As noted herein, a wide range of layouts for patterned surfaces 288 are possible, and the present techniques are not intended to be limited to any desired or particular layout. In a progressive scanning context, as imaging progresses, the sample container 110 (or patterned surface 288 therein) will undergo relative motion in an indexed direction so that each of the swaths 290 can be imaged. Coarse alignment fiducials (e.g., “auto-centering” fiducials) may be formed in or on the support, such as to allow for properly locating the grids or swaths 290 with respect to the imager, or for locating the patterned features in a processing system 224 or imaging system 10. It should be noted that in the view of FIG. 4, the surrounding flow cell in which the patterned surface 288 may be located is not shown.

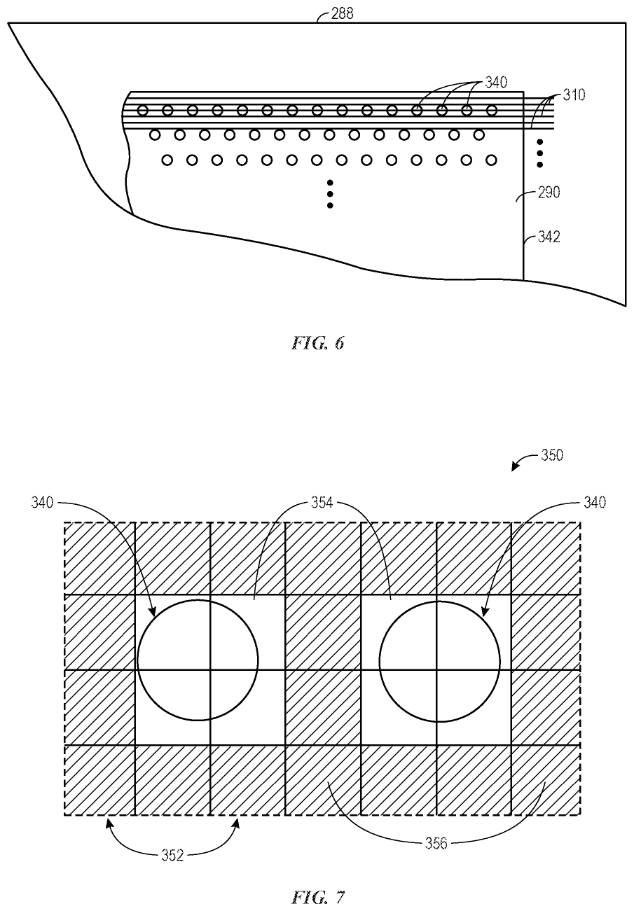

FIG. 5 is an enlargement of one of the swaths 290 of the patterned surface 288 of FIG. 4. As shown in FIG. 5, depending upon the imaging technique employed, the swath 290 may be scanned by the imaging system 10 in parallel scan lines 310 that progressively move along the swath 290. Moreover, in many systems the patterned surface will be moved slowly in one direction, as indicated by arrow 312, while the imaging optic will remain stationary. The parallel scan lines 310 will then result from the progressive movement of the sample. Each swath 290 may include regions designated as fiducial markers that can be similarly imaged and identified in resulting image data. Although not shown, area scans may also be used in which an area of the surface, as opposed to a series of lines, may be scanned each pass or acquisition.

In the illustrated example, the grid or swath 290 of the patterned surface has a width 316 which may be wider than the length 318 of the scan lines 310 of which the imaging system 10 is capable of generating or imaging in each pass. That is, the entire width 316 may not be scanned or imaged in a single pass. This may be due to the inherent limitation of the line length 318 due to the imaging optics, limitations relating to focusing or movement of components, such as mirrors or other optical components used to generate the scan lines, limitations in digital detectors, and so forth. The swath 290 may be scanned in multiple passes, and values for each of the sites may be extracted from the image data.

In FIG. 5, for example, the overall width 316 of the swath 290 can be accommodated in two overlapping areas 320 and 322. The width of each area 320 and 322, as indicated by reference numerals 324 and 326, respectively, may be slightly less than the length 318 of the scan lines 310. In such implementations, this will permit detection of a feature used to integrate the values derived from the image data, such as by reference to an edge or other feature. It may be noted that a common area or overlap 328 exists that may be imaged in both passes.

FIG. 6 illustrates, in somewhat greater detail, scan lines 310 over a plurality of sample sites 340 (e.g., wells or nanowells) in a swath 290. By way of example, in the context of a flow cell the sites 340 may be gel-filled wells, each well occupied by a nucleic acid (e.g., DNA) colony. As noted above, in some implementations, the sites 340 may be laid out in any suitable grid pattern, or even randomly. In the illustrated example, the sites 340 are laid out in a hexagonal pattern, although rectangular patterns (e.g., rectilinear patterns), and other patterns may be employed. The location of each site 340 will be known with reference to one or more fiducial or reference features, such as an edge 342 of the grid or portion of the patterned surface. In the case of random site locations, these may be located and mapped by an initial imaging sequence designed to detect the location of all sites of interest.

FIG. 7 represents a portion of an example image of a type that may be generated based upon image data collected by progressive scanning of a region of interest of a patterned surface. The actual image 350 is composed of a large number of pixels 352 each of which is assigned a digital value by the imaging system 10. In a contemplated context the pixel data, which represents the image 350, may encode values corresponding to bright pixels 354 and darker pixels 356. By way of example, dark (i.e., non-signal producing regions or pixels) and light (i.e., signal producing regions or pixels) may be assigned an intensity level of 0 and 255, respectively, or any desired other level or levels between these. In practice, various grey levels or even color encoding can be employed such that the individual sites 340 can be identified by detecting contrast or color value differences between the pixels as indicated by their individual digital values.

It may be noted that, for the purpose of illustration and explanation, FIG. 7 illustrates each site 340 (e.g., well) as spanning a multitude of pixels 352. In practice however, as well sizes continue to decrease in order to increase throughput and efficiency, each sample site 340 may effectively be imaged by a small number of pixels (e.g., 1, 2, 3, or 4 pixels). As a result, and as discussed herein, the reduced pixel coverage for each sample site 340 substantially increases the consequence of deviations from the linear motion associated with the scanning operation. By way of example, due to deviations in the expected linear motion, the primary pixels 354 associated with a given well site 340 may be misconstrued so that useful signal is missed or is applied incorrectly (e.g., to a different well). Present approaches discussed herein may be used to address such deviations.

Before discussing some presently contemplated forms, types, and uses of fiducials, a brief discussion is provided of example processing for the use, data encoding and decoding, and registration of site and image data based on the fiducial techniques disclosed. Registration of fiducials as described herein, and thereby of sites 340 detectible in image data of sequential imaging operations, can be carried out by lining up (e.g., locating and overlaying or otherwise aligning) fiducials, determining the two dimensional cross-correlation (or other measure of the similarity of fit), for example, based on the number of bright pixels 354 from the image data, and determining the offset between the fiducials in one or more dimensions (e.g., in the x- and y-dimensions). The offset can be determined, for example, via an iterative process whereby the following operations are repeated: one of the fiducials is shifted relative to the other, the change in level of correlation of fit is determined (e.g., an increase in correlation being indicated by an increase in the number of bright pixels 354 of fiducials that overlap), and a determined location of one or more of the fiducials is shifted in a direction that increases the correlation of fit. Iterations can proceed until an offset that produces an optimal correlation, a specified threshold correlation, or otherwise desired correlation is determined. A transform can be determined based on the offset and the transform can be applied to the rest of the features (e.g., sites 340) in the target image. Thus, the locations for the features in a target image can be determined by shifting the relative scale and/or orientation between the image data, using a transform based on an offset determined between fiducials in the image data when overlaid.

Any of a variety of transform models can be used. Global transforms are useful including, for example, linear transforms, geometric transforms, projective transforms, or affine transforms. The transformations can include, for example, one or more of rotation, translation, scaling, shear, and so forth. An elastic or non-rigid transform can also be useful, for example, to adjust for distortions in the target detection data or reference data. Distortions can arise when using a detection apparatus that scans a line along they dimension of an object, where the longest dimension of the line occurs along the x-dimension. For example, stretching distortions can occur along the x-dimension (and sometimes only along the x-dimension). Distortions can arise for other detectors including, for example, spreading distortions in both the x- and y-dimensions in the context of an area detector. An elastic or non-rigid transform can be used to correct for distortions, such as linear distortions present in image data obtained from line scanning instruments, or spreading distortions present in image data obtained from area detectors. Alternatively or additionally, a correction factor can be applied to the reference data, target data and/or the transform to correct distortions introduced (or expected to be introduced) by a detection apparatus. For examples where patterned features are imaged, a non-linear correction can be applied to feature locations as a function of position in the x-dimension. For example, the non-linear correction that is applied can be a third order polynomial to account for distortion arising from the optical system that was used for detection of the features.

As discussed herein, conventional fiducials that are in current use, such as “bullseye” fiducials, are two-dimensional (2-D) and registration utilizes a 2-D cross-correlation with a template image for each fiducial. This requires 2-D Fast Fourier Transforms (FFT) for each fiducial. While FFTs are highly optimized, 1-D FFTs are significantly less computationally intensive and may be more suitable for real-time processing and corrections. While the conventional fiducials are useful for correctly applying the affine transform, increasing the number of conventional fiducials may not be the optimal choice for increasing the precision of registration along the x-axis.

As discussed herein and developed in greater detail below, using a method based on 1-D FFTs (i.e., linear FFTs) along the x-axis provides high resolution in the x-dimension within a limited distance range. By way of example, a linear FFT can be performed for each pixel row within an image tile. In one embodiment the linear FFT has a length of 1,024 pixels and is centered in the image tile. The linear FFT allows the well pattern within the respective pixel row to be directly resolved. That is, by performing a linear FFT along the x-axis over the central 1,024 pixels of each pixel row, the complex phase can be extracted from the bin at the position of the peak for each pixel row of the image tile. In this manner, the conventional fiducials (as described above) may be used for absolute coordinate determination along both the x- and y-axes and to assist in locating the linear fiducials, described below), and the linear FFTs can provide detailed information for intermediate locations based on the linear fiducials.

With this in mind, and as discussed below, linear features (e.g., linear fiducials) can be incorporated onto a patterned surface. One possibility is using a number of vertical lines as linear fiducials. While this may be workable, this approach may not fully utilize the possible advantages of linear FFTs. As discussed herein, other possible embodiments of a linear fiducial design may be optimized for linear FFT-based registration. By way of example, the accuracy of an FFT-based registration method is based on a long sequence of a regular pattern. In order to avoid reliance on aliasing effects, the pitch of the pattern should be larger than the Shannon-Nyquist limit for the system, however, it should be as dense as possible within that limit in order to achieve maximum precision.

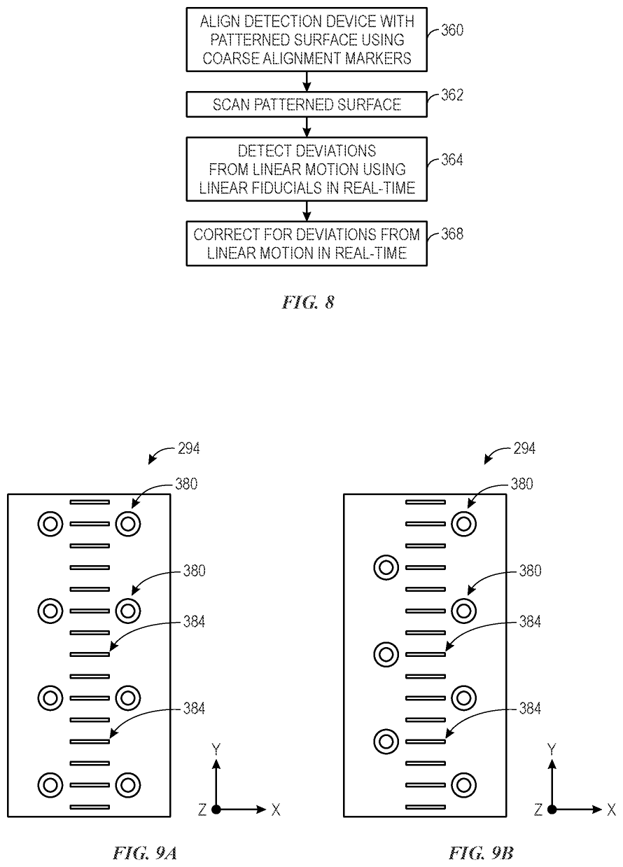

With the preceding in mind, certain embodiments discussed herein utilize a linear fiducial oriented (e.g., centered) along the x-axis of an image tile at appropriate intervals, including between each pair of conventional fiducials, but also at intervals between them. Such linear fiducials may include both sample sites (e.g., wells) and “blanks” or “blank regions”, where a well may be expected (based on an underlying or implied pattern of sites 340) but was not formed or where a well is present, but empty of sample (i.e., a “dark” well)). When the sites 340 and blanks forming a linear fiducial (e.g., a linear fiducial region) are considered together or in the aggregate, they form a linear fiducial that is optically discernible from a pattern associated with non-fiducial regions. In addition, as discussed herein coarse-alignment markers, when present, can be used to roughly align (step 360, FIG. 8) a detection device with the patterned surface, such as prior to assessing linear motion using linear fiducials as discussed herein. For example, in contexts where the detector is an optical scanning device, the flow cell surface can include one or more coarse-alignment markers that are used to roughly align the imaging optics with a location of the patterned surface, such as a location to initiate sequential area or line imaging. In this case, the coarse-alignment markers can be positioned near the proximal edge of the patterned surface, the proximal edge being at or near the initiation location for scanning of the sites 340. Coarse-alignment markers are useful when a patterned surface is scanned in multiple swaths. In certain implementations, each swath of the patterned surface will include one or more linear fiducials as described herein, which may be used for detecting (step 364) and/or correcting (step 368) deviations from linear motion during scanning (step 362) in real-time. In this way, both coarse-alignment markers and fiducials (including linear fiducials) within, among, or between swaths can be used by a detection system to locate features (e.g., sites 340) on the patterned surface. In certain embodiments coarse alignment markers may be absent from the flow cell and instead the corresponding alignment functions are performed using other fiducials present on the patterned surface.

With the preceding background and context in mind, FIGS. 9A and 9B respectively depict differing examples of a layout of an image tile 294. As previously noted, in conventional approaches, certain fiducials 380 (e.g., conventional or coarse alignment fiducials) may be in the form of a “bullseye” pattern consisting of concentric and alternating dark and bright circles. Each image tile 294 scanned from the flow cells may have from 4 to 8 (e.g., 4, 6, or 8) conventional fiducials 380 and the image data acquired of such fiducials 380 may be used for absolute positioning and in the generation of geometric transforms, such as affine transforms, that may be used to perform image corrections, such as to compensate for shifts, skews, and magnification changes along both principal axes of the image. The image data acquired of such conventional fiducials 380 (such as bullseye fiducials), however, does not provide sufficient information for non-linear corrections of the image geometry, i.e., to identify and correct for deviations from linear movement of the sample relative to the imaging optics.

In addition to the fiducials 380 used for conventional registration and site positioning, the image tile 294 of FIGS. 9A and 9B is shown as including linear fiducials 384 that may be used for determining deviations from linear motion during a scan operation. By way of example, such linear fiducials 384 may be used to perform high resolution localization within the x-dimension and, in the example shown in FIG. 9A, may be positioned on the image tile 294 between pairs of aligned conventional fiducials 380 as well as at intervals between the paired conventional fiducials 380. In a differing layout, and as shown in FIG. 9B, conventional fiducials 380 may be spaced apart (i.e., offset) in the depicted y-dimension instead of being aligned. Due to the known offset, the conventional fiducials 380 (e.g., coarse alignment or “bullseye” fiducials) may still be used for coarse alignment functions as well as for localizing linear fiducials 384 as discussed herein.

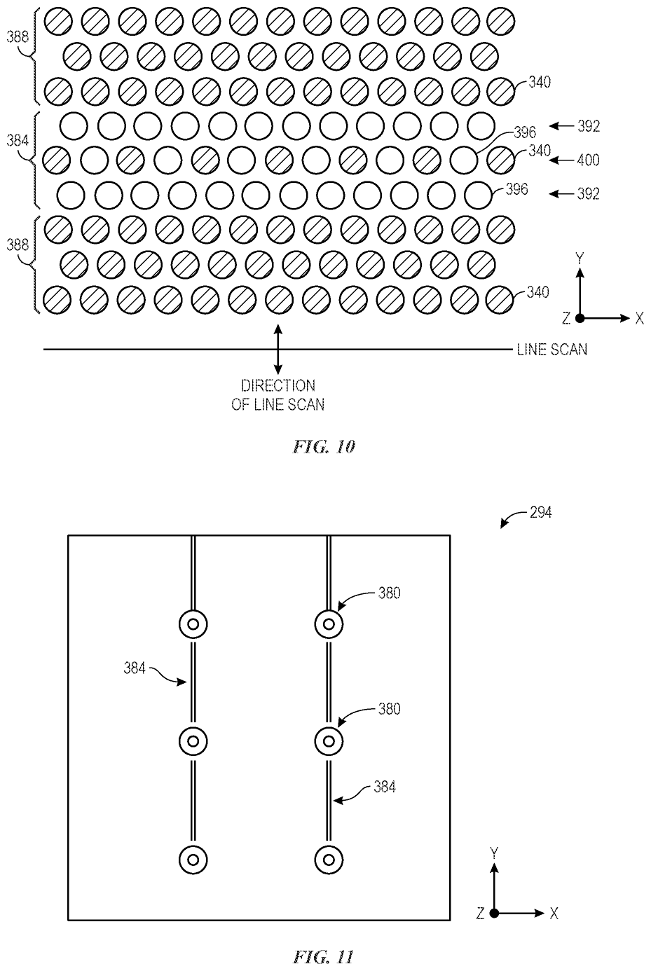

In an example implementation of a linear fiducial 384, and turning to FIG. 10, each linear fiducial in the depicted example comprises three rows based on the normal well pattern present in non-fiducial regions 388. In the depicted example, the three rows corresponding to the linear fiducial 384 are flanked on the top and bottom with sample sites 340 in the normal, periodic well pattern present in non-fiducial regions 388. The linear fiducial 384 in this example comprises two outer rows 392 of “blank” wells or sites 396 or are otherwise “blank” (i.e., do not have wells formed at the positions that would correspond to the pattern present in non-fiducial regions 388 or have empty, dark wells). In this example, the “blank” rows 392 address issues that may arise related to alternating well locations on adjacent rows. In addition, the adjacent rows of bordering non-fiducial regions 388 will have the same sample site (e.g., well) alignment as the center row 400 of the linear fiducial 384. In one sample embodiment, in order to minimize or otherwise limit the effects of optical distortion, the length of the linear fiducial 384 is at least 1,024 pixels and it is centered in the respective swath such that the non-fiducial well pattern may be present on the sides of the linear fiducial 384 as well as above and below the linear fiducial 384.

In the depicted example, the center row of the linear fiducial 384 includes well sites 340, which may be capable of holding sample and thus may be used to acquire and collect sample data. As described herein, if the spacing (i.e., pitch) of the well pattern is below the Shannon-Nyquist sampling limit for the optical system the period of the well pattern cannot be directly represented in the 1-D Fourier transform. With this in mind, the depicted example alternates sample sites 340 with blanks 396 so as to bring the effective fiducial pitch within the center row 400 above the limit. As a result, a linear fiducial as shown in FIG. 10 will have significantly fewer lost well site locations compared to the conventional fiducials, and can thus be positioned at smaller intervals. The linear fiducial design illustrated has higher resolution compared to a conventional fiducial, but with a limited total range. Correspondingly, the illustrated linear fiducial 384 is better suited than a conventional fiducial (e.g., bullseye fiducial)_for detecting relative displacement along the x-axis (e.g., deviation from a linear motion associated with a scan path). Conversely, however, the linear fiducial 384 has little to no sensitivity in the y-dimension.

In an alternative embodiment to that illustrated in FIG. 10, and as shown in FIG. 11 and as noted above, the linear fiducials 384 that may be used to correct for x-dimension deviations or shifts may instead involve “vertical” fiducials (i.e., linear fiducials running length-wise in the y-dimension. By way of example, such “vertical” linear fiducials 384 may be formed as a trench or sharp line formed on the substrate, such as running between the conventional or coarse alignment fiducials 380.

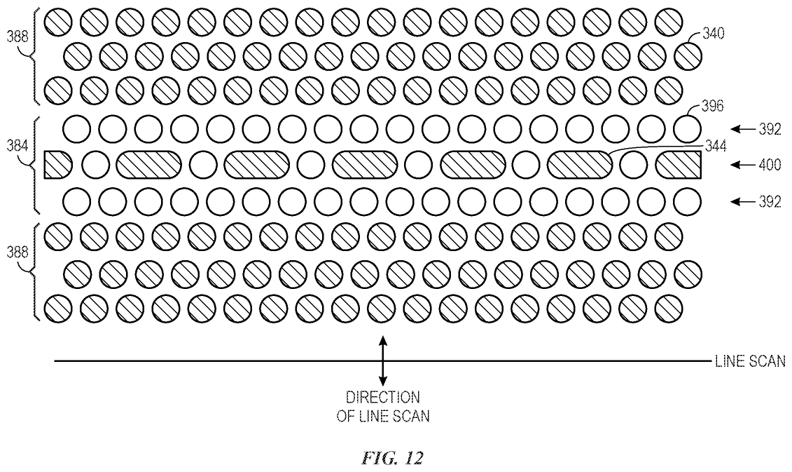

Turning to FIG. 12, a further example of an implementation of a linear fiducial 384 is depicted. In this example, each linear fiducial 384 comprises three rows based generally on the normal well pattern present in the non-fiducial regions 388. In the depicted example, the three rows corresponding to the linear fiducial 384 are flanked on the top and bottom with sample sites 340 in the normal, periodic well pattern present in the non-fiducial regions 388. The linear fiducial 384 in this example comprises two outer rows 392 of “blank” wells or sites 396 or are otherwise “blank” (i.e., do not have wells formed at the positions that would correspond to the pattern 388 or have empty, dark wells). As in preceding examples, the “blank” rows 392 address matters that may arise related to the tight pitch density associated with alternating well locations on adjacent rows in a high-density context for the sample wells 340.

In addition, in the depicted example of FIG. 12 the center row of the linear fiducial 384 includes horizontally-oriented (with the direction of line scan corresponding to a vertical dimension) elongated sample well sites 344 (also referred to herein as linear features 344) alternated with blank sites 396. The linear features 344 in the depicted embodiment span two normally spaced sites 340 plus the intervening pitch distance in the depicted example, though other geometries and/or dimensions are also contemplated. As described herein, if the spacing (i.e., pitch) of the well pattern is below the Shannon-Nyquist sampling limit for the optical system the period of the well pattern cannot be directly represented in the 1-D Fourier transform. With this in mind, the depicted example alternates linear features 344 with blanks 396 so as to bring the effective fiducial pitch within the center row 400 above the limit.

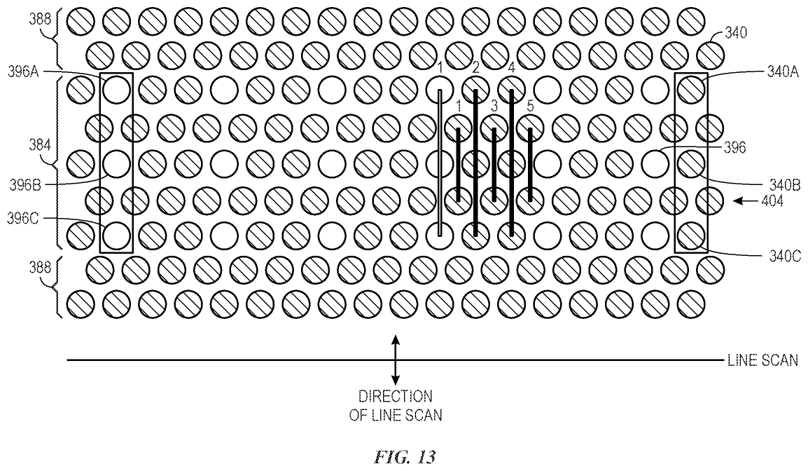

In further examples illustrated in FIGS. 13-15 the linear fiducials 384 are depicted as comprising more than three rows of sample sites 340 and blanks 396. By way of example, in the depicted embodiments the linear fiducials 384 comprise five rows of sample sites 340 and blanks 396. As noted herein, in order to minimize or otherwise limit the effects of optical distortion, the length of the linear fiducial 384 may be at least 1,024 pixels and the linear fiducial 384 may be centered (with respect to the x-dimension) in the respective swath.

For example, turning to FIG. 13, the depicted linear fiducial 384 comprises five rows. The top, center, and bottom rows of the linear fiducial 384 comprise a periodic, alternating arrangement of blank sites 396 and sample sites 340. In this example, the periodic arrangement is: one blank site 396, followed by two sample sites 340, followed by a blank site 396, and so forth. The linear fiducial 384 of FIG. 13 includes two non-blank rows 404 of sample sites 340 with no intervening or spacing blank sites 396 within the row. One non-blank row 404 is positioned between the top and center rows of the linear fiducial 384 while the other non-blank row 404 is positioned between the center and bottom rows of the linear fiducial 384. As in preceding examples, the breaks in the overall pattern provided by the blank sites 396 within the linear fiducial 384 may provide useful regions where the pitch or spacing between sample sites 340 within the linear fiducial 384 exceeds the Shannon-Nyquist sampling limit and, further, allows deviations in linear motion to be detected.

With further reference to FIG. 13, in certain embodiments a linear fiducial 384 comprises two or more non-blank sites 340 (e.g., sample wells) generally aligned in a column substantially parallel to the scan direction, such as the scan direction of a line scan. As shown in FIG. 13, three non-blank sites 340A, 340B, 340C are aligned in a column substantially parallel to the scan direction. In certain aspects, two or more non-blank sample sites 340 aligned in a column substantially parallel provide a larger “positive” signal upon Fourier transform since their values are additive.

Further, in certain embodiments, a linear fiducial 384 comprises two or more blank sites 396 generally aligned in a column substantially parallel to the scan direction, such as the scan direction of a line scan. As shown in FIG. 13, three blank sites 396A, 396B, 396C are aligned in a column substantially parallel to the scan direction. In certain aspects, two or more blank sites 396 aligned in a column substantially parallel provide a larger “negative” signal upon Fourier transform since their values are additive.

As further illustrated, in certain embodiments a linear fiducial 384 comprises two or more non-blank wells 340 generally aligned in a column substantially parallel to the scan direction and comprises two or more blank sites 396 generally aligned in a column substantially parallel to the scan direction. For example, as shown in FIG. 13, the linear fiducial 384 comprises five columns (denoted by filled lines 1-5) of two or more non-blank sample sites 340 between columns (one of which is denoted by the non-filled line 1) of two or more blank sites 396.

In certain aspects, the arrangement of non-blank sample sites 340 (e.g., sample wells) and blank sites 396 provide increased detectability of the linear fiducial 384 while also allowing the non-blank wells to be used as sample/analyte regions.

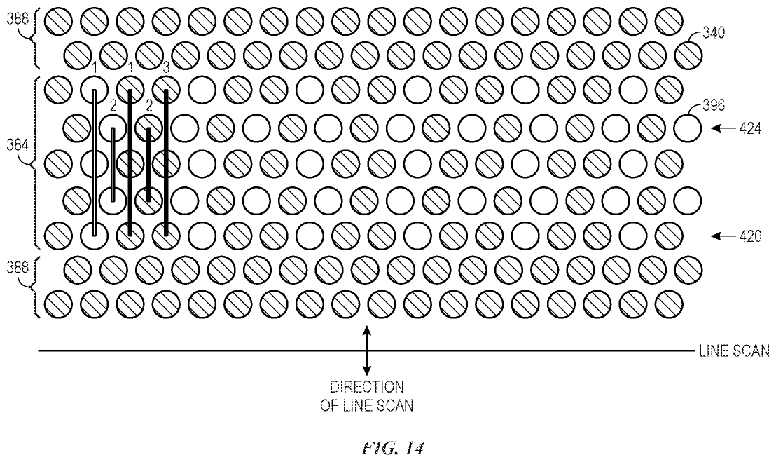

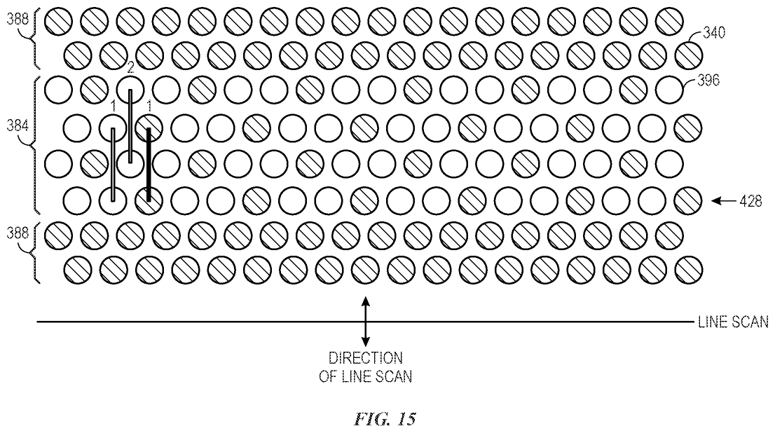

Turning to FIG. 14, a further example of a linear fiducial 384 is illustrated. Unlike the example linear fiducial 384 of FIG. 13, where rows of alternating blank sites 396 and sample sites 340 are alternated with full rows of sample sites 340, the example linear fiducial 384 of FIG. 14 utilizes rows of blank sites 396 and sample sites 340 having different periodic, repeating patterns. In this example, rows 420 of the linear fiducial 384 (here constituting the bottom, center, and top rows of the linear fiducial 384) comprise sample sites 340 and blank sites 396 in a one to two alternating pattern (e.g., one blank site 396, two sample sites 340, one blank site 396, and so forth). Positioned between the rows 420 (i.e., between the top and center rows and between the center and bottom rows) are rows 424 of the linear fiducial 384, in which the sample sites 340 and blank sites 396 are in a one to one alternating pattern (e.g., one blank site 396, one sample site 340, one blank site 396, and so forth). As in preceding examples, the breaks in the overall pattern provided by the blank sites 396 within the linear fiducial 384 may provide useful regions where the pitch or spacing between sample sites 340 within the linear fiducial 384 exceeds the Shannon-Nyquist sampling limit and, further, allows deviations in linear motion to be detected.

With further reference to FIG. 14, in certain embodiments a linear fiducial 384 comprises two or more non-blank sample sites 340 (e.g., sample wells) generally aligned in a column substantially parallel to the scan direction and comprises two or more blank sites 396 generally aligned in a column substantially parallel to the scan direction. For example, as shown in FIG. 14, the linear fiducial 384 comprises three columns of two or more non-blank sample sites 340 (denoted by filled lines 1-3) between sets (e.g., pairs) of two columns of two or more blank sites 396 (one pair of which is denoted by the non-filled lines 1 and 2).

Turning to FIG. 15, a further example is illustrated in which the rows of the linear fiducial 384 comprise blank sites 396 and sample sites 340 in a repeating pattern that is offset from row to row. In this example, there are four rows in the linear fiducial 384. Unlike the example of FIG. 14, the rows 428 of the linear fiducial 384 of FIG. 15 each have the same pattern of alternation (e.g., two blank sites 396, one sample site 340, two blank sites 396, and so forth), but are offset from one another in adjacent rows. As a result, in the two interior rows of the linear fiducial 384 each sample site 340 has no other sample sites 340 adjacent, and instead is surrounded by adjacent blank sites 396. As in preceding examples, the breaks in the overall pattern provided by the blank sites 396 within the linear fiducial 384 may provide useful regions where the pitch or spacing between sample sites 340 within the linear fiducial 384 exceeds the Shannon-Nyquist sampling limit and, further, allows deviations in linear motion to be detected.

With further reference to FIG. 15, in certain embodiments a linear fiducial 384 comprises two or more non-blank sample sites 340 (e.g., sample wells) generally aligned in a column substantially parallel to the scan direction and comprises two or more blank sites 396 generally aligned in a column substantially parallel to the scan direction. For example, as shown in FIG. 15, the linear fiducial 384 comprises one column of two or more non-blank sample sites 340 (denoted by filled line 1) between sets (e.g., pairs) of two columns of two or more blank sites 396 (one pair of which is denoted by the non-filled lines 1 and 2).

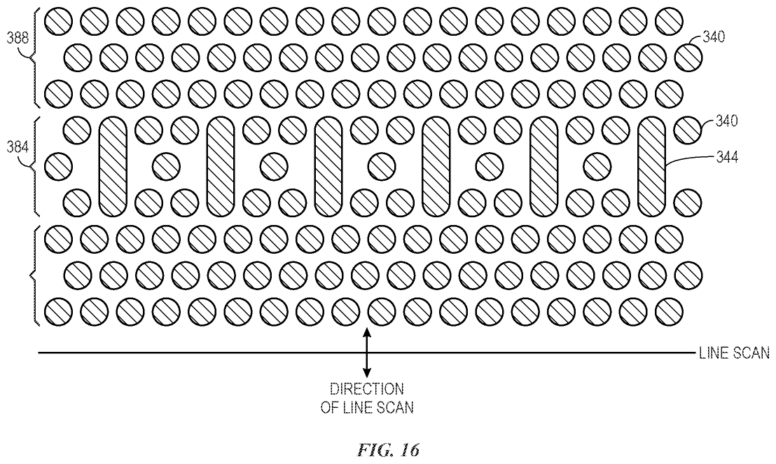

Turning to FIGS. 16 through 20, five additional embodiments of a linear fiducial are depicted and described. As with the embodiment illustrated in FIG. 12, elongated sample well sites 344 (also referred to herein as linear features 344) are incorporated into the embodiments depicted in FIGS. 16 through 20. However, unlike the embodiment of FIG. 12, in which the linear features 344 are disposed horizontally along the x-dimension of the substrate (i.e., each linear feature 344 is within a row of the linear fiducial 384), in the depicted example embodiments of FIGS. 16 through 20, the linear features 344 are instead disposed vertically along the y-dimension of the substrate (i.e., in the direction of line scanning), thereby spanning multiple rows (e.g., two, three, four, etc.) of the linear fiducial 384 while, within each row, each linear feature 344 only occupies the space associated with a single sample site 340 within the respective row. As previously noted, in some embodiments the elongated sample sites (e.g., linear features 344), as with other sample sites 340, may be used as sample/analyte regions and thus may provide sites for meaningful data collection or generation in contrast to techniques in which the regions or spots associated with a fiducial are associated with fixed or pre-determined markers.

By way of example, and turning to FIG. 16, one embodiment is illustrated. In this example, each linear fiducial 384 comprises three rows based generally on the normal well pattern present in the non-fiducial regions 388. In the depicted example, the three rows corresponding to the linear fiducial 384 include vertically-oriented linear features 344 that span, in the depicted example, all three rows corresponding to the linear fiducial 384. That is, the vertically-oriented linear features 344 in the depicted embodiment span three normally spaced sample sites 340 plus the intervening pitch distance, though other geometries and/or dimensions are also contemplated. As will be appreciated, in other embodiments the vertically-oriented linear features 344 may span less than all rows of the linear fiducial 384. In the depicted example the linear fiducial 384 is flanked on the top and bottom with sample sites 340 in the normal, periodic well pattern present in the non-fiducial regions 388. As the linear fiducial may have a limited extent in the x-dimension (e.g., 1,024 pixels), it may also be flanked on the sides by the normal, periodic well pattern present in the non-fiducial regions 388.

In the depicted example the embodiment of a linear fiducial 384 does not include blank sites 396, as discussed and described elsewhere herein. Instead, both the depicted sample sites 340 and linear features 344 are configured to hold sample and/or analyte undergoing analysis, and thus no substrate surface space is lost to non-sample holding blank sites 396.

In this example, the topmost and bottommost rows of the linear fiducial 384 comprise sample sites 340 and portions of linear features 344 in a one to two alternating pattern (e.g., one linear feature 344, two sample sites 340, one linear feature 344, and so forth). The center row of the linear fiducial 384 in the depicted example (i.e., between the top and bottom rows) instead exhibits a one-to-one alternating pattern of linear features 344 and sample sites 340 (e.g., one linear feature 344, one sample site 340, one linear feature 344, and so forth). In this example, the changes in pitch between the linear features 344 and sample sites 340 may provide useful regions where the pitch or spacing between sample sites 340 and/or between sample sites 340 and linear features 344 within the linear fiducial 384 exceeds the Shannon-Nyquist sampling limit and, further, allows deviations in linear motion to be detected. Further, as noted above, this may be facilitated by the vertically-oriented linear features 344 providing a larger “positive” signal upon Fourier transform.

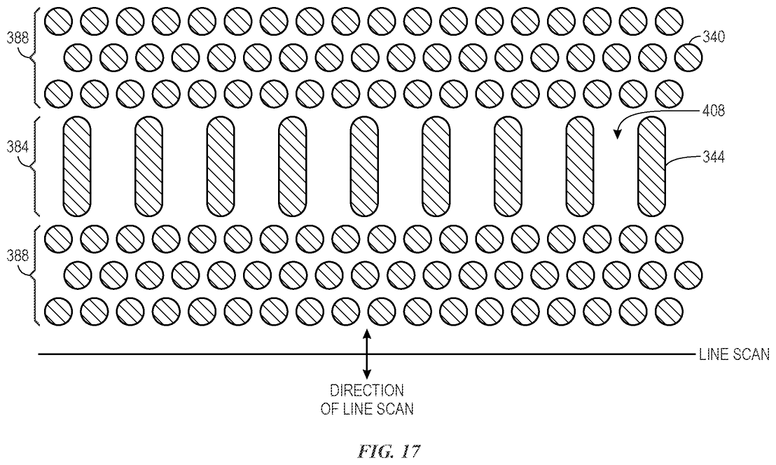

In a further example, and turning to FIG. 17, in this example, each linear fiducial 384 corresponds in extent to three rows of the normal well pattern present in the non-fiducial regions 388. In the depicted example, the three rows corresponding to the linear fiducial 384 include vertically-oriented linear features 344 that span, in the depicted example, all three rows corresponding to the linear fiducial 384. That is, the linear features 344 in the depicted embodiment span the height of the linear fiducial 384 corresponding to the direction of line scan and, in this example corresponding to the extent associated with three normally spaced sample sites 340 plus the intervening pitch distance, though other geometries and/or dimensions are also contemplated. As will be appreciated, in other embodiments the vertically-oriented linear features 344 may span less than all rows of the linear fiducial 384 and in such cases may be vertically aligned or may be alternately offset in the vertical dimension (i.e., the direction of line scan illustrated). In the depicted example the linear fiducial 384 is flanked on the top and bottom with sample sites 340 in the normal, periodic well pattern present in the non-fiducial regions 388. As the linear fiducial may have a limited extent in the x-dimension (e.g., 1,024 pixels), it may also be flanked on the sides by the normal, periodic well pattern present in the non-fiducial regions 388.

In the depicted example, within the linear fiducial 384 the vertically-oriented linear features 344 may be offset or spaced apart horizontally, such as via a spacing or blank region 408 that may correspond to blanks or blanks spaces or regions (i.e., blank wells 396 or regions where no wells, blank or otherwise, are formed), as discussed herein. For the purpose of illustration and clarification, in the depicted example the corresponding spacing of the blank or unformed wells is not shown so as to better illustrate the extent of the blank regions 408 in a real-world context, though at the expense of the underlying pattern being less evident. As in preceding examples, the blank spaces or regions 408 help address matters that may arise related to the pitch density associated with alternating well locations on adjacent rows in a high-density context for the sample wells. In this manner, issues arising from alternating well locations on adjacent rows that are too closely spaced may be addressed by the linear fiducial 384. Further, the effective pitch in the linear fiducial 384 at certain regions having blanks regions 408 or no wells is increased so as not to be below the Shannon-Nyquist sampling limit for the optical system, thus facilitating representation and/or determination of the period of the well pattern using 1-D Fourier transform. Indeed, in certain aspects the vertically-oriented linear features 344 provide a larger “positive” signal upon Fourier transform. With this in mind, the depicted example alternates vertically-oriented linear features 344 with blanks regions 408 so as to achieve regions within the linear fiducial 384 in which the effective fiducial pitch is above the Shannon-Nyquist sampling limit for the optical system.

As previously noted, in the preceding and other examples described herein, the horizontal spacing between features comprising a linear fiducial may be something other than an integer multiple of the well spacing associated with the well pattern (i.e., the spacing between adjacent wells in the non-fiducial hexagonal well pattern). By way of reference, the preceding example illustrated in FIG. 17 has a spacing between linear features 344 of the linear fiducial 384 that in an integer multiple (here, 2×) of the well spacing. However, it should be appreciated that the spacing within a linear fiducial 384 between such linear features 344 need not be an integer multiple of well spacing, and may instead be a non-integer multiple of well spacing. Further, and with the preceding in mind, in various implementations of linear fiducials 384 spacing patterns (e.g., alternating spacing patterns) between linear features 344 of the linear fiducial 384 may be employed. By way of example, where a “unit” is a length unit that may or may not be related to the underlying pattern of wells, a linear feature spacing pattern (in units) of 2:3:2:3 . . . ; 1:2:1:2 . . . ; 1:3:1:3 . . . ; and so forth may be employed within a linear fiducial 384.

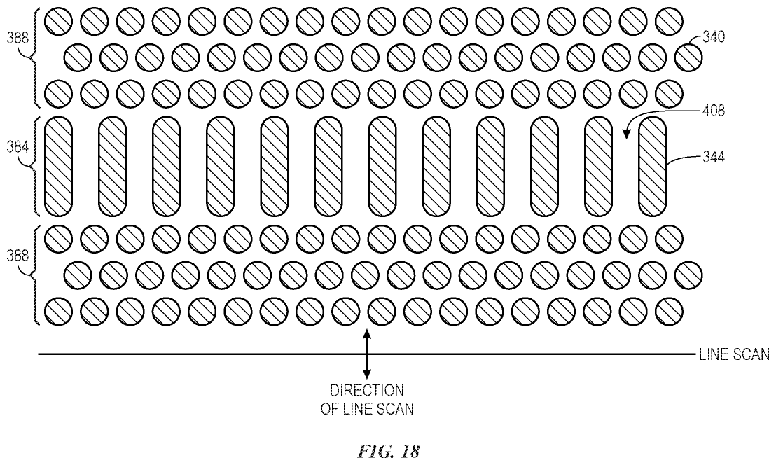

With the preceding in mind, and turning to the examples illustrated in FIGS. 18-20, various aspects of such variations are illustrated. Turning to FIG. 18, in this example an arrangement of linear features 344 similar to what is seen in the embodiment of FIG. 17 is depicted. However, in contrast to the prior example, the spacing between linear features 344 (illustrated as corresponding to blank regions 408) is a non-integer multiple of the well spacing corresponding to wells 340 of the non-fiducial regions 388. For the purpose of illustration, in this example, the linear features 344 are spaced apart in the linear fiducial 384 by a distance corresponding to 1.5× the well spacing. As will be appreciated however, and suitable non-integer multiple of well spacing (e.g., 1.25×, 1.33×, 1.5×, 1.66×1.75×, and so forth) may be employed.

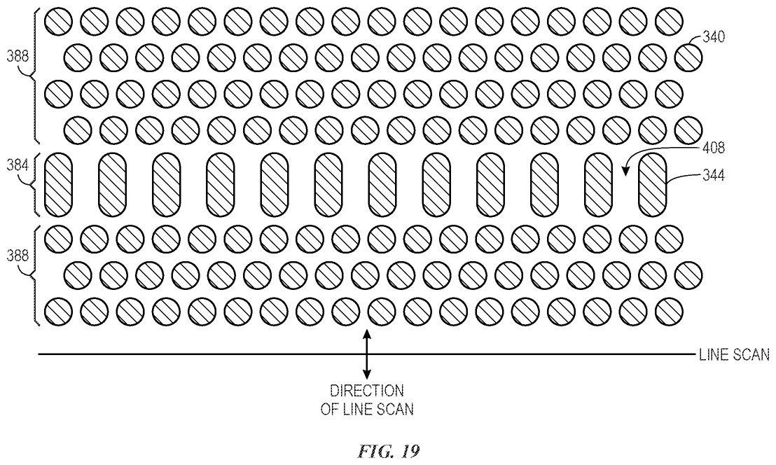

Turning to FIG. 19, in this example, the spacing between linear features 344 of the linear fiducial 384 is also a non-integer multiple of well spacing corresponding to wells 340 of the non-fiducial regions 388. In addition, the linear features 344 of the linear fiducial 384 are shown as having a lesser extent (e.g., length) than in the prior examples. In particular, in the depicted example, the vertically-oriented linear features 344 two rows of the underlying hexagonal pattern of the non-fiducial regions 388 (i.e., the area of two normally spaced sample sites 340 plus the intervening pitch distance. In this manner, the linear fiducial 384 may be designed of configured to occupy a lesser vertical extent of the substrate, thereby allowing a greater area to be allowed for conventional sample wells 340.

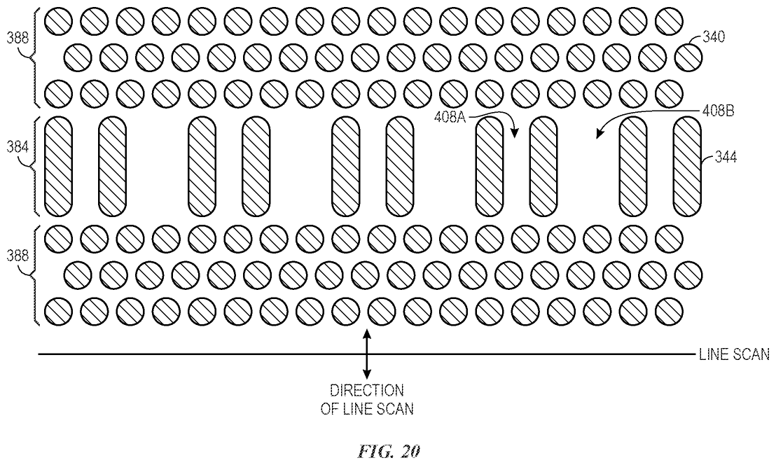

In a further example, and turning to FIG. 20, in certain embodiments the spacing between linear features 344 of the linear fiducial 384 may incorporate an alternating pattern of spacing between linear features 344. That is, the blank regions 408 between linear features may be of two different, alternated widths or extents. An example of this is illustrated in FIG. 20. In the depicted example, each linear feature 344 is separated from the nearest linear feature on a first side by a blank region 408A having a first width or extent and is separated from the nearest linear feature on a second side (e.g., the opposite or opposing side) by a blank region 408B having a second width or extent different than the first width or extent. In this manner a pattern of linear features 344 may be formed which itself provides information as to position in the x-dimension. As will be appreciated the spacing between linear features with respect to both the first and second blank regions 408A and 408B may or may not be related to the underlying pattern of wells. That is one or both spacing intervals may or may not be based on an integer multiple of the well spacing present in the hexagonal pattern observed in the non-fiducial regions. As in other examples described herein, the alternated linear features 344 with blanks regions 408A and 408B provide regions within the linear fiducial 384 in which the effective fiducial pitch is above the Shannon-Nyquist sampling limit for the optical system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A patterned flow cell, comprising:
a substrate;
a plurality of sample sites in a non-fiducial region of the substrate, wherein the plurality of sample sites are arranged in a periodic pattern;
a plurality of coarse-alignment fiducials formed on the substrate separate from the plurality of sample sites;
a plurality of linear fiducials formed on the substrate, wherein each linear fiducial comprises sample sites and blanks arranged in accordance with the periodic pattern, wherein each blank corresponds to a location in the periodic pattern where a well should be located but is not or where an empty sample well is located.

2. The patterned flow cell of claim 1, wherein the periodic pattern comprises a hexagonal or a rectilinear pattern.

3. The patterned flow cell of claim 1, wherein the coarse-alignment fiducials comprise bullseye patterns.

4. The patterned flow cell of claim 1, wherein a subset of the plurality of linear fiducials are formed on the substrate between pairs of coarse-alignment fiducials.

5. The patterned flow cell of claim 1, wherein the plurality of coarse-alignment fiducials are in a vertically offset pattern with respect to the plurality of linear fiducials.

6. The patterned flow cell of claim 1, wherein the linear fiducials of the plurality of linear fiducials are formed in an x-dimension corresponding to a direction in which rows of pixels are scanned when imaging the patterned flow cell.

7. The patterned flow cell of claim 1, wherein each row of each linear fiducial comprises one or more blanks.

8. The patterned flow cell of claim 1, wherein each linear fiducial comprises one or more rows with no blanks each flanked by rows with one or more blanks.

9. The patterned flow cell of claim 1, wherein each linear fiducial comprises three, four, or five rows of the periodic pattern.

10. The patterned flow cell of claim 1, wherein each linear fiducial comprises one or more rows comprising an alternating pattern of sample sites and blanks.

11. A patterned flow cell, comprising:
a substrate;
a plurality of sample sites in a non-fiducial region of the substrate, wherein the plurality of sample sites are arranged in a periodic pattern;
a plurality of coarse-alignment fiducials formed on the substrate separate from the plurality of sample sites;
a plurality of linear fiducials formed on the substrate, wherein each linear fiducial comprises linear features comprising elongated sample sites wherein each linear feature spans an area corresponding to two or more sample sites.

12. The patterned flow call of claim 11, wherein each linear fiducial further comprises one or more blanks, wherein each blank corresponds to a location in the periodic pattern where a well should be located but is not or where an empty sample well is located.

13. The patterned flow call of claim 11, wherein each linear fiducial comprises:
two or more rows corresponding to the periodic pattern and comprising:
one or both of sample sites or blanks; and
a plurality of linear features in alternation with the sample sites or blanks of the respective linear fiducial, wherein each linear feature spans multiple rows of the periodic pattern.

14. The patterned flow cell of claim 13, wherein each blank, if present, corresponds to a location in the periodic pattern where a well should be located but is not or where an empty sample well is located.

15. The patterned flow cell of claim 11, wherein each linear fiducial comprises:
a center row comprises an alternating pattern of linear features and blanks; and
a pair of flanking rows comprising all blanks.

16. The patterned flow cell of claim 11, wherein the linear features are oriented horizontally so as to correspond in orientation to rows of the periodic pattern, wherein the periodic pattern is a hexagonal pattern.

17. The patterned flow cell of claim 11, wherein the linear features are oriented vertically so as to be perpendicular in orientation to rows of the periodic pattern, wherein the periodic pattern is a hexagonal pattern.

18. The patterned flow cell of claim 11, wherein the linear features are spaced apart by a spacing distance that is a non-integer multiple of a distance between sample sites in the periodic pattern.

19. The patterned flow cell of claim 11, wherein the linear features are spaced apart by alternating first and second spacing distances.

20. A method for correcting for deviations from a linear scan path in an imaging operation, comprising:
advancing a patterned surface undergoing an imaging operation along a linear scan path;
imaging the patterned surface as it is advanced along the linear scan path, wherein the patterned surface comprises a plurality of linear fiducials;
detecting deviations from the linear scan path using the plurality of linear fiducials; and
correcting for the deviations from the linear scan path while the patterned surface is imaged.

21. The method of claim 20, wherein the deviations from the linear scan path are detected in real-time during the imaging.

22. The method of claim 21, wherein imaging the patterned surface comprises performing confocal line scanning of the patterned surface.

23. The method of claim 20 further comprising:
aligning a detection device with the patterned surface using a plurality of coarse alignment fiducials prior to imaging the patterned surface.

24. The method of claim 20, wherein each linear fiducial comprises sample sites and blanks arranged in accordance with a periodic pattern of the patterned surface, wherein each blank corresponds to a location in the periodic pattern where a sample site should be located but is not or where an empty sample site is located.

25. The method of claim 20, wherein each linear fiducial comprises linear features comprising elongated sample sites and oriented in a direction corresponding to the linear scan path.

26. The method of claim 20, wherein detecting deviations from the linear scan path comprises performing a one-dimensional (1-D) fast Fourier transform over each pixel row.

27. A sequencing instrument, comprising:
a sample stage configured to support a sample container;
an objective lens, a photodetector, and a light source configured to operate in combination to image the sample container when present on the sample stage; and
a controller configured to perform operations comprising:
advancing the sample container undergoing an imaging operation along a linear scan path;
imaging a patterned surface of the sample container as it is advanced along the linear scan path, wherein the patterned surface comprises a plurality of linear fiducials;
detecting deviations from the linear scan path using the plurality of linear fiducials; and
correcting for the deviations from the linear scan path while the patterned surface is imaged by the sequencing instrument.

28. The sequencing instrument of claim 27, wherein the controller is configured to detect deviations from the linear scan path in real-time during the imaging.

29. The sequencing instrument of claim 27, wherein the controller is further configured to perform operations comprising:
aligning the objective lens with the patterned surface using a plurality of coarse alignment fiducials prior to imaging the patterned surface.

30. The sequencing instrument of claim 27, wherein the controller is configured to detect deviations from the linear scan path by performing a one-dimensional (1-D) fast Fourier transform over each pixel row of the patterned surface.
